(19) United States
(12) Patent Application Publication
(10) Pub. No.: US 2019/0061719 A1
(43) Pub. Date: Feb. 28, 2019

(54) Brake Apparatus and Brake Control Method

(71) Applicant: Hitachi Automotive Systems, Ltd., Hitachinaka-shi, lbaraki (JP)

(72) Inventor: Toshihiko HIGASHI, Iwata-shi, Shizuoka (JP)

(73) Assignee: Hitachi Automotive Systems, Ltd., Hitachinaka-shi ,Ibaraki (JP)

(21) Appl. No.: 16/081,536

(22) PCT Filed: Feb. 24, 2017
(86) PCT No.: PCT/JP2017/007008

§ 371 Date: Aug. 31, 2018

(30) Foreign Application Priority Data
Mar. 2, 2016 (JP) 2016-040368

(51) Int. Cl. B60T 8/36; B60T 13/20; B60T 13/68; B60T 8/40

(52) U.S. Cl. CPC B60T 8/368; B60T 13/20; B60T 8/885; B60T 8/4072; B60T 8/365; B60T 13/686

(57) ABSTRACT

Provided is a brake apparatus and a brake control method capable of improving accuracy of control of a wheel cylinder hydraulic pressure. The brake apparatus includes a first brake circuit connecting a master cylinder configured to generate a brake hydraulic pressure according to a pedal operation and a plurality of wheel cylinders configured to generate a braking force on each of wheels of a vehicle by application of the brake hydraulic pressure to each other, a pump configured to increase a pressure of brake fluid in the master cylinder and transmit the brake fluid having the increased pressure to the plurality of wheel cylinders via a second brake circuit connected to the first brake circuit, a plurality of pressure increase control valves provided in the first brake circuit, and a first target upstream hydraulic pressure calculation portion configured to calculate a target hydraulic pressure in the second brake circuit in such a manner that the target hydraulic pressure exceeds a maximum value of target wheel cylinder hydraulic pressures of respective wheel cylinders corresponding to the individual wheels by an amount of a change in the hydraulic pressure in the second brake circuit when a pressure increase control valve corresponding to a wheel other than a maximum hydraulic pressure wheel, of the plurality of pressure increase control valves, is opened.

### TECHNICAL FIELD

The present invention relates to a brake apparatus and a brake control method.

### BACKGROUND ART

PTL 1 discloses a brake apparatus including a pump that increases a pressure of brake fluid in a master cylinder. In this conventional technique, a target wheel cylinder is realized by actuating the pump so as to achieve a wheel cylinder hydraulic pressure of a wheel corresponding to a maximum target wheel cylinder hydraulic pressure (a maximum hydraulic pressure wheel), and opening/closing a pressure increase control valve and a pressure reduction control valve provided between the pump and a wheel cylinder so as to achieve a wheel cylinder hydraulic pressure of each of the other wheels (wheels other than the maximum hydraulic pressure wheel).

### CITATION LIST

### Patent Literature

PTL 1: Japanese Patent Application Public Disclosure No. 2000-159094

### SUMMARY OF INVENTION

### Technical Problem

However, the above-described conventional technique has a problem of, upon opening the corresponding pressure increase control valve when increasing the wheel cylinder hydraulic pressure of the wheel other than the maximum hydraulic pressure wheel, causing the wheel cylinder hydraulic pressure of the maximum hydraulic pressure wheel to temporarily fall below the target wheel cylinder hydraulic pressure, thereby reducing accuracy of control of the wheel cylinder hydraulic pressure.

An object of the present invention is to provide a brake apparatus and a brake control method capable of improving the accuracy of the control of the wheel cylinder hydraulic pressure.

### Solution of Problem

According to one embodiment of the present invention, a brake apparatus includes a first brake circuit connecting a master cylinder configured to generate a brake hydraulic pressure according to a pedal operation and a plurality of wheel cylinders configured to generate a braking force on each of wheels of a vehicle by application of the brake hydraulic pressure to each other, a pump configured to increase a pressure of brake fluid in the master cylinder and transmit the brake fluid having the increased pressure to the plurality of wheel cylinders via a second brake circuit connected to the first brake circuit, a plurality of pressure increase control valves provided in the first brake circuit, and a first target upstream hydraulic pressure calculation portion configured to calculate a target hydraulic pressure in the second brake circuit in such a manner that the target hydraulic pressure exceeds a maximum value of target wheel cylinder hydraulic pressures of respective wheel cylinders corresponding to the individual wheels by an amount of a change in the hydraulic pressure in the second brake circuit when a pressure increase control valve corresponding to a wheel other than a maximum hydraulic pressure wheel, of the plurality of pressure increase control valves, is opened.

Therefore, it is possible to improve the accuracy of the control of the wheel cylinder hydraulic pressure.

### BRIEF DESCRIPTION OF DRAWINGS

FIG. 1 schematically illustrates a configuration of a brake apparatus according to a first embodiment together with a hydraulic circuit.

FIG. 2 is a block diagram of control of an upstream hydraulic pressure according to the first embodiment.

FIG. 3 is a flowchart illustrating a flow of processing for controlling a W/C hydraulic pressure by an ECU 90 according to the first embodiment.

FIG. 4 is a flowchart illustrating a flow of processing for controlling a pressure increase valve according to the first embodiment.

FIG. 5 is a timing chart illustrating a function of the control of the upstream hydraulic pressure according to the first embodiment.

FIG. 6 is a timing chart when ABS control is actuated on all of wheels during boosting control according to the first embodiment.

FIG. 7 is a flowchart illustrating a flow of processing for calculating a target upstream hydraulic pressure according to a second embodiment.

FIG. 8 is a timing chart when the ABS control is actuated on all of the wheels during the boosting control according to the second embodiment.

FIG. 9 is a flowchart illustrating a flow of the processing for calculating the target upstream hydraulic pressure according to a third embodiment.

FIG. 10 is a timing chart illustrating a function of the control of the upstream hydraulic pressure according to the third embodiment.

FIG. 11 is a timing chart when the ABS control is actuated on all of the wheels during the boosting control according to the third embodiment.

### DESCRIPTION OF EMBODIMENTS

### First Embodiment

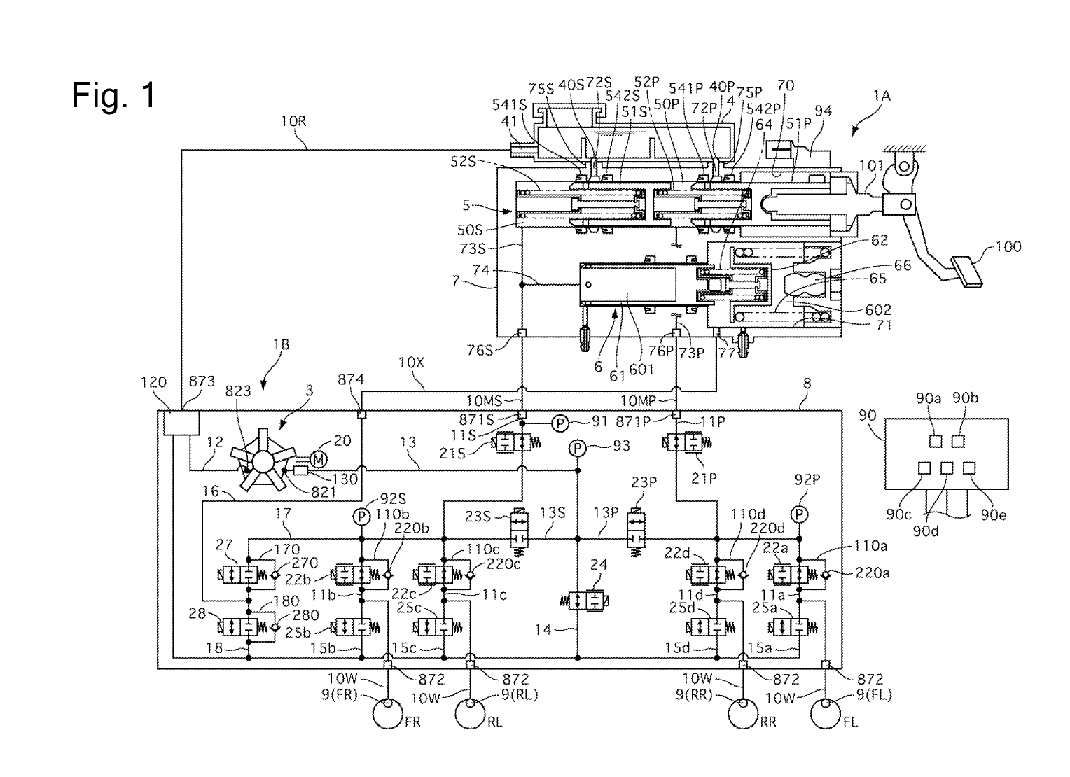

FIG. 1 schematically illustrates a configuration of a brake apparatus according to a first embodiment together with a hydraulic circuit.

The brake apparatus according to the first embodiment is employed for an electric vehicle. The electric vehicle is, for example, a hybrid automobile including an engine and a motor generator as a prime mover that drives wheels, or an electric automobile including only the motor generator as the prime mover. The electric automobile can carry out regenerative braking for braking the vehicle by regenerating electric energy from motion energy of the vehicle with use of a regenerative braking apparatus including the motor generator. The brake apparatus applies a frictional braking force with use of a hydraulic pressure to each of wheels FL to RR of the vehicle. A brake actuation unit is provided for each of the wheels FL to RR. The brake actuation unit is a hydraulic pressure generation portion including a wheel cylinder (hereinafter referred to as W/C) 9. The brake actuation unit is, for example, a disk-type brake, and includes a caliper (a hydraulic brake caliper). The caliper includes a brake disk and brake pads. The brake disk is a brake rotor rotatable integrally with a tire. The brake pads are disposed with predetermined clearances with respect to the brake disk, and contact the brake disk by being moved by a hydraulic pressure in the W/C 9. The frictional braking force is generated by the contacts of the brake pads to the brake disk. The brake apparatus includes brake pipes of two systems (a primary P system and a secondary S system). A brake pipe configuration is, for example, an X-split pipe configuration. The brake apparatus may employ another pipe configuration, such as a front/rear split pipe configuration. Hereinafter, when a member provided in correspondence with the P system and a member provided in correspondence with the S system should be distinguished from each other, indices P and S will be added at the ends of the respective reference numerals. The brake apparatus supplies brake fluid as hydraulic fluid (hydraulic oil) to each of the brake actuation units via a brake pipe, and generates a brake hydraulic pressure in the W/C 9. By this operation, the brake apparatus applies a hydraulic braking force to each of the wheels FL to RR.

The brake apparatus includes a first unit 1A and a second unit 1B. The first unit 1A and the second unit 1B are set up in, for example, a motor room isolated from a driving compartment of the vehicle. These units 1A and 1B are connected to each other via a plurality of pipes. The plurality of pipes includes: master cylinder (hereinafter referred to as M/C) pipes (a first brake circuit) 10M including a primary pipe 10MP and a secondary pipe 10MS; W/C pipes 10W; a backpressure chamber pipe (a third brake circuit) 10X; and an intake pipe 10R. Except for the intake pipe 10R, each of the pipes 10M, 10W, and 10X is a metallic brake pipe (a metallic pipe), and, in particular, a steel tube such as a double walled steel tube. Each of the pipes 10M, 10W, and 10X includes a linear portion and a bent portion, and is disposed between ports while being turned in another direction at the bent portion. Both ends of each of the pipes 10M, 10W, and 10X each include a male pipe joint processed by flared processing. The intake pipe 10R is a brake hose (a hose pipe) formed so as to become flexible from a material such as rubber. Ends of the intake pipe 10R are connected to a port 873 and the like.

A brake pedal 100 is a brake operation member that receives an input of a brake operation performed by a driver. An input rod 101 is vertically rotatably connected to the brake pedal 100. The first unit 1A is an M/C unit including a brake operation unit mechanically connected to the brake pedal 100, and an M/C 5. The first unit 1A includes a reservoir tank 4, an M/C housing 7, the M/C 5, a stroke sensor 94, and a stroke simulator 6. The reservoir tank 4 is a brake fluid source storing the brake fluid therein, and is a low-pressure portion opened to an atmospheric pressure. Replenishment ports 40 and a supply port 41 are provided in the reservoir tank 4. The intake pipe 10R is connected to the supply port 41. The M/C housing 7 is a casing that contains (houses) the M/C 5 and the stroke simulator 6 therein. The M/C housing 7 includes therein a cylinder 70 for the M/C 5, a cylinder 71 for the stroke simulator 6, and a plurality of oil passages (fluid passages). The plurality of oil passages includes replenishment oil passages 72, supply oil passages (the first brake circuit) 73, and a positive pressure oil passage 74. The M/C housing 7 includes a plurality of ports therein, and each of the ports is opened on an outer peripheral surface of the M/C housing 7. The plurality of ports includes replenishment ports 75P and 75S, supply ports 76, and a backpressure port 77. The replenishment ports 75P and 75S are connected to replenishment ports 40P and 40S of the reservoir tank 4, respectively. The M/C pipes 10M are connected to the supply ports 76, and the backpressure chamber pipe 10X is connected to the backpressure port 77. One end and the other end of each of the replenishment oil passages 72 are connected to the replenishment port 75 and the cylinder 70, respectively.

The M/C 5 is connected to the brake pedal 100 via the input rod 101, and generates an M/C hydraulic pressure according to an operation performed by the driver on the brake pedal 100. The M/C 5 includes pistons 51 axially movable according to the operation on the brake pedal 100. The pistons 51 are contained in the cylinder 70, and define hydraulic chambers 50. The M/C 5 is a tandem-type cylinder, and includes, as the pistons 51, a primary piston 51P pushed by the input rod 101 and a secondary piston 51S configured as a free piston. These pistons 51P and 51S are arranged in series. A primary chamber (a first chamber) 50P is defined by the pistons 51P and 51S, and a secondary chamber (a second chamber) 50S is defined by the secondary piston 51S. One end and the other end of each of the supply oil passages 73 are connected to the hydraulic chamber 50 and the supply port 76, respectively. Each of the hydraulic chambers 50P and 50S is replenished with the brake fluid from the reservoir tank 4, and generates the M/C hydraulic pressure by the movement of the above-described piston 51. A coil spring 52P as a return spring is disposed between these pistons 51P and 51S in the primary chamber 50P. A coil spring 52S as a return spring is disposed between a bottom portion of the cylinder 70 and the piston 51S in the secondary chamber 50S. Piston seals 541 and 542 are set on an inner periphery of the cylinder 70. The piston seals 541 and 542 are a plurality of seal members that seals between an outer peripheral surface of each of the pistons 51P and 51S and an inner peripheral surface of the cylinder 70 while being in sliding constant with each of the pistons 51P and 51S. Each of the piston seals is a well-known seal member cup-shaped in cross-section that includes a lip portion on an inner diameter side (a cup seal). Each of the piston seals permits a flow of the brake fluid in one direction and prohibits or reduces a flow of the brake fluid in the other direction with the lip portion in sliding contact with the outer peripheral surface of the piston 51. A first piston seal 541 permits a flow of the brake fluid from the replenishment port 40 toward the primary chamber 50P or the secondary chamber 50S, and prohibits or reduces a flow of the brake fluid in an opposite direction. A second piston seal 542 permits a flow of the brake fluid toward the replenishment port 40, and prohibits or reduces a flow of the brake fluid out of the replenishment port 40. The stroke sensor 94 outputs a sensor signal according to a movement amount (a stroke) of the primary piston 51P.

The stroke simulator 6 is actuated according to the brake operation performed by the driver, and provides a reaction force and a stroke to the brake pedal 100. The stroke simulator 6 includes a piston 61, a positive pressure chamber 601, a backpressure chamber 602, and elastic members (a first spring 64, a second spring 65, and a damper 66). The positive pressure chamber 601 and the backpressure chamber 602 are provided in the cylinder 70, and are defined by the piston 61. The elastic members bias the piston 61 in a direction for reducing a volume of the positive pressure chamber 601. A bottomed cylindrical retainer member 62 is disposed between the first spring 64 and the second spring 65. One end and the other end of the positive pressure oil passage 74 are connected to a secondary-side supply oil passage 73S and the positive pressure chamber 601, respectively. The brake fluid is delivered from the M/C 5 (the secondary chamber 50S) to the positive pressure chamber 601 according to the brake operation performed by the driver, by which the pedal stroke is generated, and the pedal reaction force of the brake operation performed by the driver is also generated due to the biasing forces of the elastic members. The first unit 1A does not include an engine negative-pressure booster that boosts the brake operation force by utilizing an intake negative pressure generated by an engine of the vehicle.

The second unit 1B is provided between the first unit 1A and the brake actuation unit. The second unit 1B is connected to the primary chamber 50P via the primary pipe 10MP, connected to the secondary chamber 50S via the secondary pipe 10MS, connected to the W/C 9 via the W/C pipes 10W, and connected to the backpressure chamber 602 via the backpressure pipe 10X. Further, the second unit 1B is connected to the reservoir tank 4 via the intake pipe 10R. The second unit 1B includes a second unit housing 8, a motor 20, a pump 3, a plurality of electromagnetic valves 21 and the like, a plurality of hydraulic pressure sensors 91 and the like, and an electronic control unit 90 (hereinafter referred to as an ECU). The second unit housing 8 is a casing that contains (houses) the pump 3 and valve bodies of the electromagnetic valves 21 and the like therein. The second unit housing 8 includes therein circuits (brake hydraulic circuits) of the above-described two systems (the P system and the S system), through which the brake fluid flows. The circuits of the two systems are formed by a plurality of oil passages. The plurality of oil passages includes supply oil passages (the first brake circuit) 11, an intake oil passage (a fourth brake circuit and a return flow fluid passage) 12, a discharge oil passage (a second brake circuit) 13, a pressure adjustment oil passage (the fourth brake circuit and the return flow fluid passage) 14, pressure reduction oil passages 15, a backpressure oil passage (a third brake circuit) 16, a first simulator oil passage (the third brake circuit) 17, and a second simulator oil passage 18. Further, the second unit housing 8 includes therein a reservoir (the fourth brake circuit) 120, which is a fluid pool, and a damper 130. A plurality of ports is formed inside the second unit housing 8, and these ports are opened on an outer surface of the second unit housing 8. The plurality of ports includes M/C ports 871 (a primary port 871P and a secondary port 871S), an intake port 873, a backpressure port 874, and W/C ports 872. The primary pipe 10MP is connected to the primary port 871P. The secondary pipe 10MS is connected to the secondary port 871S. The intake pipe 10R is connected to the supply port 873. The backpressure chamber pipe 10X is connected to the backpressure port 874. Each of the W/C pipes 10W is connected to each of the W/C ports 872.

The motor 20 is a rotary electric motor, and includes a rotational shaft for driving the pump 3. The motor 20 may be a brushless motor or may be a brushed motor. The motor 20 includes a resolver that detects a rotational angle of the rotational shaft. The resolver functions as a rotational number sensor that detects the number of rotations of the motor 20. The pump 3 introduces therein the brake fluid in the reservoir tank 4 by the rotational driving of the motor 20, and discharges the brake fluid toward the W/Cs 9. In the first embodiment, a plunger pump including five plungers, which is excellent in terms of, for example, a noise and vibration performance, is employed as the pump 3. The pump 3 is used in common by both of the S and P systems. The pump is driven by the single motor 20. Each of the electromagnetic valves 21 and the like is a solenoid valve that operates according to a control signal, and a valve body thereof is stroked to thus switch opening/closing of the oil passage (establishes or blocks communication through the oil passage) according to power supply to the solenoid. The electromagnetic valves 21 and the like each generate a control hydraulic pressure by controlling a communication state of the above-described circuit to adjust a flow state of the brake fluid. The plurality of electromagnetic valves 21 and the like include shut-off valves 21, pressure increase valves (a pressure increase control valve) 22, communication valves 23, a pressure adjustment valve 24, pressure reduction valves 25, a stroke simulator IN valve 27, and a stroke simulator OUT valve 28. The shut-off valves 21, the pressure increase valves 22, and the pressure adjustment valve 24 are each a normally opened electromagnetic valve opened when no power is supplied thereto. The communication valves 23, the pressure reduction valves 25, the stroke simulator IN valve 27, and the stroke simulator OUT valve 28 are each a normally closed electromagnetic valve closed when no power is supplied thereto. The shut-off valves 21, the pressure increase valves 22, and the pressure adjustment valve 24 are each a proportional control valve, an opening degree of which is adjusted according to a current supplied to a solenoid. The communication valves 23, the pressure reduction valves 25, the stroke simulator IN 27, and the stroke simulator OUT valve 28 are each an ON/OFF valve, opening/closing of which is controlled to be switched between two values, i.e., switched to be either opened or closed. The proportional control valve can also be used as these valves. The hydraulic pressure sensors 91 and the like detect a discharge pressure of the pump 3 and the M/C hydraulic pressure. The plurality of hydraulic pressure sensors includes an M/C hydraulic pressure sensor 91, a discharge pressure sensor (a hydraulic pressure detection portion) 93, and W/C hydraulic pressure sensors (the hydraulic pressure detection portion) 92 including a primary pressure sensor 92P and a secondary pressure sensor 92S.

In the following description, the brake hydraulic circuit of the second unit 1B will be described. Members corresponding to the individual wheels FL to RR will be distinguished from one another if necessary, by indices a to d added at the ends of reference numerals thereof, respectively. One end side of the supply oil passage 11P is connected to the primary port 871P. The other end side of the supply oil passage 11P branches off into an oil passage 11a for the front left wheel and an oil passage 11d for the rear right wheel. Each of the oil passages 11a and 11d is connected to the W/C port 872 corresponding thereto. One end side of the supply oil passage 11S is connected to the secondary port 871S. The other end side of the supply oil passage 11S branches off into an oil passage 11b for the front right wheel and an oil passage 11c for the rear left wheel. Each of the oil passages 11b and 11c is connected to the W/C port 872 corresponding thereto. The shut-off valves 21 are provided on the above-described one end sides of the supply oil passages 11. The shut-off valves 21 include a primary shut-off valve (a primary cut valve) 21P in the P system and a secondary shut-off valve (a secondary cut valve) 21S in the S system. The pressure increase valve 22 is provided in each of the oil passages 11 on the above-described other end side of the supply oil passage 11. A bypass oil passage 110 is provided in parallel with each of the oil passages 11 while bypassing the pressure increase valve 22, and a check valve 220 is provided in the bypass oil passage 110. The check valve 220 permits only a flow of the brake fluid directed from one side where the W/C port 872 is located toward the other side where the M/C port 871 is located.

The intake oil passage 12 connects the reservoir 120 and an intake port 823 of the pump 3 to each other. One end side of the discharge oil passage 13 is connected to a discharge port 821 of the pump 3. The other end side of the discharge oil passage 13 branches off into an oil passage (a communication fluid passage) 13P for the P system and an oil passage (the communication fluid passage) 13S for the S system. Each of the oil passages 13P and 13S is connected to a portion of the supply oil passage 11 between the shut-off valve 21 and the pressure increase valves 22. The damper 130 is provided on the above-described one end side of the discharge oil passage 13. The communication valve 23 is provided in each of the oil passages 13P and 13S on the above-described other end side. Each of the oil passages 13P and 13S functions as a communication passage connecting the supply oil passage 11P of the P system and the supply oil passage 11S of the S system to each other. The pump 3 is connected to each of the W/C ports 872 via the above-described communication passages (the discharge oil passages 13P and 13S) and the supply oil passages 11P and 11S. The pressure adjustment oil passage 14 connects a portion of the discharge oil passage 13 between the damper 130 and the communication valves 23, and the reservoir 120 to each other. The pressure adjustment valve 24 is provided in the pressure adjustment oil passage 14. The pressure reduction oil passage 15 connects a portion of each of the oil passages 11a to 11d of the supply oil passages 11 between the pressure increase valve 22 and the W/C port 872, and the reservoir 120 to each other. The pressure reduction valve 25 is provided in the pressure reduction oil passage 15.

One end side of the backpressure oil passage 16 is connected to the backpressure port 874. The other end side of the backpressure oil passage 16 branches off into the first simulator oil passage 17 and the second simulator oil passage 18. The first simulator oil passage 17 is connected to a portion of the supply oil passage 11S between the shut-off valve 21S and the pressure increase valves 22b and 22c. The stroke simulator IN valve 27 is provided in the first simulator oil passage 17. A bypass oil passage 170 is provided in parallel with the first simulator oil passage 17 while bypassing the stroke simulator IN valve 27, and a check valve 270 is provided in the bypass oil passage 170. The check valve 270 permits only a flow of the brake fluid directed from one side where the backpressure oil passage 16 is located toward the other side where the supply oil passage 11S is located. The second simulator oil passage 18 is connected to the reservoir 120. The stroke simulator OUT valve 28 is provided in the second simulator oil passage 18. A bypass oil passage 180 is provided in parallel with the second simulator oil passage 18 while bypassing the stroke simulator OUT valve 28, and a check valve 280 is provided in the bypass oil passage 180. The check valve 280 permits only a flow of the brake fluid directed from one side where the reservoir 120 is located toward the other side where the backpressure oil passage 16 is located.

The hydraulic pressure sensor 91 is provided between the shut-off valve 21S and the secondary port 871S in the supply oil passage 11S. The hydraulic pressure sensor 91 detects a hydraulic pressure at this portion (a hydraulic pressure in the positive pressure chamber 601 of the stroke simulator 6, namely the M/C hydraulic pressure). The hydraulic pressure sensors 92 are provided between the shut-off valves 21 and the pressure increase valves 22 in the first oil passages 11. The hydraulic pressure sensors 92 detect hydraulic pressures at these portions (corresponding to the W/C hydraulic pressures). The hydraulic pressure sensor 93 is provided between the damper 130 and the communication valves 23 in the discharge oil passage 13. The hydraulic pressure sensor 93 detects a hydraulic pressure at this portion (the discharge pressure of the pump).

Information input to the ECU 90 includes detection values of the hydraulic pressure sensors 91 and the stroke sensor 94 and the like, and information regarding a running state that is transmitted from the vehicle side (a wheel speed, a yaw rate, a lateral G, and the like). The ECU 90 controls the W/C hydraulic pressure of each of the wheels FL to RR by actuating the electromagnetic valves 21 and the like and the motor 20 with use of the input information according to a built-in program. By this control, the ECU 90 can perform various kinds of brake control (ABS control for preventing or reducing a slip of the wheel due to the braking, TCS control for preventing or reducing a slip of the wheel due to driving, boosting control for reducing a required driver's brake operation force, brake control for controlling the motion of the vehicle, automatic brake control such as adaptive cruise control, regenerative cooperative brake control, and the like). The control of the motion of the vehicle includes vehicle behavior stabilization control such as electronic stability control. In the regenerative cooperative brake control, the ECU 90 controls the W/C hydraulic pressures so as to achieve a target deceleration (a target braking force) in cooperation with regenerative brake.

The ECU 90 includes a target W/C hydraulic pressure calculation portion 90a and a driving control portion 90b. The target W/C hydraulic pressure calculation portion 90a calculates a target W/C hydraulic pressure of each of the wheels FL to RR. The driving control portion 90b drives the motor 20, the plurality of electromagnetic valves 21, and the like according to the target W/C hydraulic pressure. In the boosting control, the target W/C hydraulic pressure calculation portion 90a calculates the target W/C hydraulic pressure that realizes a predetermined boosting rate, i.e., an ideal characteristic of a relationship between the pedal stroke and a brake hydraulic pressure requested by the driver (a vehicle deceleration requested by the driver), based on the detected pedal stroke. In the boosting control, the target W/C hydraulic pressure of each of the wheels FL to RR is set to an equal pressure to one another. In the regenerative cooperative brake control, the target W/C hydraulic pressure calculation portion 90a calculates such a target W/C hydraulic pressure that a sum of the regenerative braking force input from a control unit of the regenerative braking apparatus and a hydraulic braking force corresponding to the target W/C hydraulic pressure can satisfy the vehicle deceleration requested by the driver. In the ABS control, the TCS control, the brake control for controlling the motion of the vehicle, and the automatic brake control, the target W/C hydraulic pressure calculation portion 90a calculates the target W/C hydraulic pressure of a control target wheel according to a target value in this control (a target slip rate for the ABS control and the TCS control, a target yaw rate for the brake control for controlling the motion of the vehicle, and a target vehicle speed or a target deceleration for the automatic brake control).

The driving control portion 90b realizes the target W/C hydraulic pressure by actuating the pump 3 according to a predetermined times of rotations, controlling the shut-off valve 21 and the communication valve 23 in a closing direction and an opening direction, respectively, and controlling the pressure adjustment valve 24 in a closing direction in such a manner that a hydraulic pressure in the discharge oil passage 13 (hereinafter also referred to as an upstream oil passage), which is a hydraulic pressure upstream of the pressure adjustment valve 24, matches a target upstream hydraulic pressure according to the target W/C hydraulic pressure, when the brake operation is performed by the driver. The target upstream hydraulic pressure will be described below. An average of the respective detection values of the primary pressure sensor 92P, the secondary pressure sensor 92S, and the discharge pressure sensor 93 is used as the upstream hydraulic pressure. When a failure has occurred in one of the individual hydraulic sensors 92P, 92S, and 93, an average of the detection values of the normal two hydraulic sensors is used as the upstream hydraulic pressure. At this time, the driving control portion 90b causes the stroke simulator 6 to function by controlling the stroke simulator OUT valve 28 in an opening direction. The driving control portion 90b realizes the target W/C hydraulic pressure by controlling the pressure increase valve 22 and the pressure reduction valve 25 when increasing/reducing or maintaining the W/C hydraulic pressure of the control target wheel in the ABS control, the TCS control, the brake control for controlling the motion of the vehicle, or the like. More specifically, the driving control portion 90b controls the pressure reduction valve 25 in an opening direction when reducing the W/C hydraulic pressure of the control target wheel, controls the pressure increase valve 22 in a closing direction when maintaining the W/C hydraulic pressure of the control target wheel, and controls the pressure increase valve 22 in an opening direction when increasing the W/C hydraulic pressure of the control target wheel.

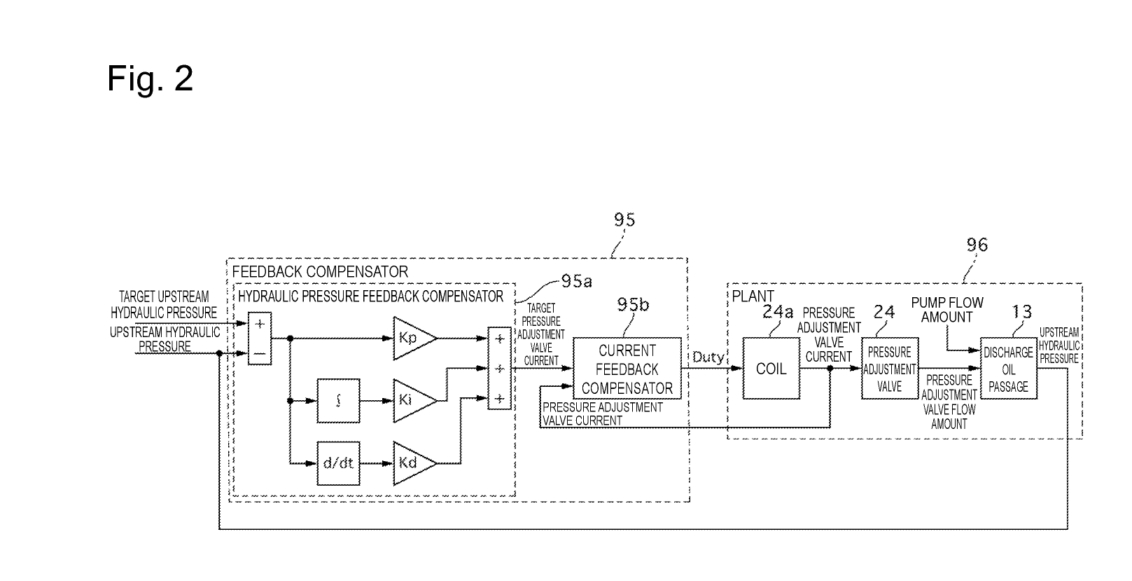

FIG. 2 is a block diagram of control of the upstream hydraulic pressure according to the first embodiment. A feedback compensator 95 includes a hydraulic pressure feedback compensator (a feedback calculation portion) 95a and a current feedback compensator 95b. The hydraulic pressure feedback compensator 95a calculates a target pressure adjustment valve current from a difference between the target upstream hydraulic pressure and the actual upstream hydraulic pressure. In the present example, the target pressure adjustment valve current is calculated by PID control, but may be calculated by a known control method. Feedback gains Kp, Ki, and Kd of the PID control are adjusted by conducting an experiment or a simulation and referring to chronological data so as to be able to perform the control highly responsively within a range that does not cause a feedback control system to diverge. The current feedback compensator 95b calculates Duty by the PID control from a difference between the target pressure adjustment valve current and a detected pressure adjustment valve current. A plant 96 in the control of the upstream hydraulic pressure is a coil 24a of the pressure adjustment valve 24, the pressure adjustment valve 24, and the discharge oil passage 13. Regarding the coil 24a, the pressure adjustment valve current is determined from Duty. Regarding the pressure adjustment valve 24, a pressure adjustment valve flow amount is determined from the pressure adjustment valve current. Regarding the discharge oil passage 13, the upstream hydraulic pressure is determined from the pressure adjustment valve flow amount, a pump flow amount, and hydraulic stiffness of the discharge oil passage 13. The upstream hydraulic pressure can be highly responsively controlled without diverging by controlling the upstream hydraulic pressure according to the above-described PID control.

[Processing for Controlling W/C Hydraulic Pressure]

The brake apparatus according to the first embodiment performs control of the W/C hydraulic pressure like an example that will be described below, with the aim of improving accuracy of the control of the W/C hydraulic pressure. The ECU 90 includes a first target upstream hydraulic pressure calculation portion (a target upstream hydraulic pressure calculation portion) 90c, a second target upstream hydraulic pressure calculation portion 90d, and a target W/C hydraulic pressure comparison portion 90e in addition to the target W/C hydraulic pressure calculation portion 90a and the driving control portion 90b, as a configuration for realizing the control of the W/C hydraulic pressure.

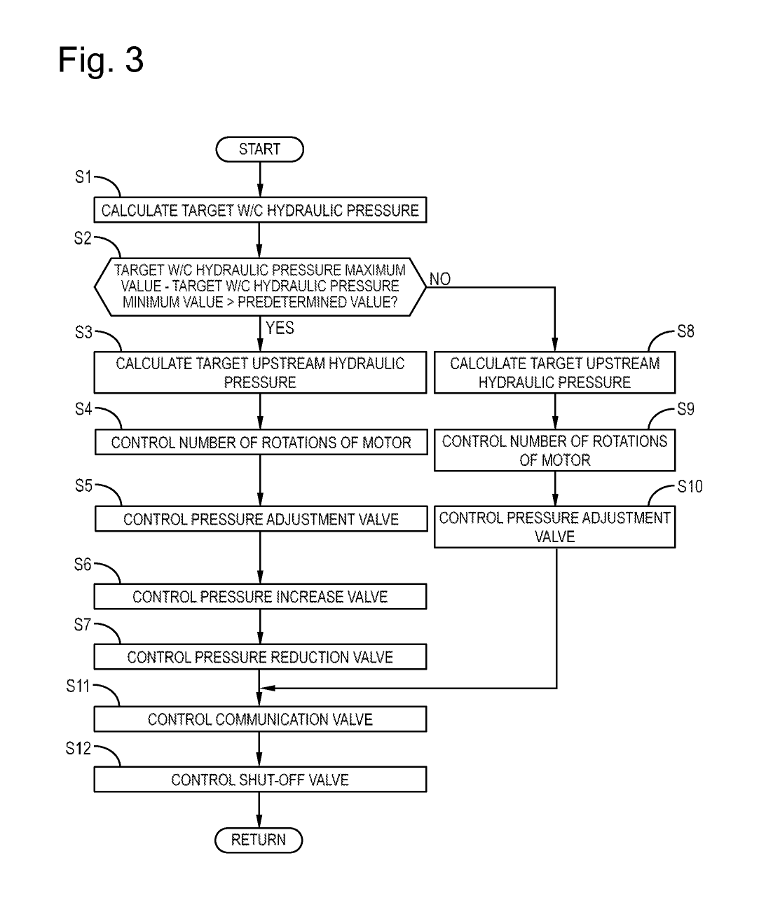

FIG. 3 is a flowchart illustrating a flow of processing for controlling the W/C hydraulic pressure by the ECU 90 according to the first embodiment.

Step S1 is a step of calculating the target W/C hydraulic pressure, and the ECU 90 calculates the target W/C hydraulic pressure of each of the W/Cs 9 in compliance with brake control in progress by the target W/C hydraulic pressure calculation portion 90a.

Step S2 is a step of comparing the target W/C hydraulic pressures, and the ECU 90 determines whether a difference between a maximum value (a target W/C hydraulic pressure maximum value) and a minimum value (a target W/C hydraulic pressure minimum value) of the individual target W/C hydraulic pressures calculated in step S1 exceeds a predetermined value by the target W/C hydraulic pressure comparison portion 90e. If the determination in step S2 is YES, the processing proceeds to step S3. If the determination in step S2 is NO or all of the individual target W/C hydraulic pressures are equal to one another, the processing proceeds to step S8. The predetermined value is set within a range that keeps the behavior of the vehicle unchanged.

Step S3 is a step of calculating a first target upstream hydraulic pressure, and the ECU 90 calculates the target upstream hydraulic pressure by the first target upstream hydraulic pressure calculation portion 90c. The target upstream hydraulic pressure is set to a value acquired by adding a maximum upstream hydraulic pressure reduction amount dP_UPPER_ERROR_MAX to the target W/C hydraulic pressure maximum value. A value used as dP_UPPER_ERROR_MAX is a maximum value of a difference between the target upstream hydraulic pressure and the upstream hydraulic pressure (an upstream hydraulic pressure reduction amount dP_UPPER_ERROR) that is generated when each of the pressure increase valves 22 are individually opened in control of the pressure increase valve, which will be described below.

In step S4, the ECU 90 controls the number of rotations of the motor 20 by the driving control portion 90b. The target number of rotations of the motor is set to the number of rotations of the motor used when the feedback gains Kp, Ki, and Kd in the block of the control of the upstream hydraulic pressure illustrated in FIG. 2 are adjusted.

In step S5, the ECU 90 controls the pressure adjustment valve 24 based on the block of the control of the upstream hydraulic pressure illustrated in FIG. 2 by the driving control portion 90b.

In step S6, the ECU 90 controls the pressure increase valve 22 by the driving control portion 90b. Details of the control of the pressure increase valve will be described below.

In step S7, the ECU 90 controls the pressure reduction valve 25 based on (the target W/C hydraulic pressure−an estimated W/C hydraulic pressure) and the estimated W/C hydraulic pressure by the driving control portion 90b.

Step S8 is a step of calculating a second target upstream hydraulic pressure, and the ECU 90 calculates the target upstream hydraulic pressure by the second target upstream hydraulic pressure calculation portion 90d. The target upstream hydraulic pressure is set to the target W/C hydraulic pressure.

In step S9, the ECU 90 controls the number of rotations of the motor by the driving control portion 90b. The ECU 90 calculates a brake fluid amount to be fed to each of the W/Cs 9 from a difference between the target upstream hydraulic pressure and the upstream hydraulic pressure and from hydraulic stiffness of each of the W/Cs 9, calculates a brake fluid amount necessary for the entire brake apparatus by adding them, and determines the target number of rotations of the motor from a required increase gradient.

In step S10, the ECU 90 controls the pressure adjustment valve 24 based on the block of the control of the upstream hydraulic pressure illustrated in FIG. 2 by the driving control portion 90b.

In step S11, the ECU 90 controls the communication valve 23 by the driving control portion 90b. The communication valve 23 is constantly opened during the control of the W/C hydraulic pressure.

In step S12, the ECU 90 controls the shut-off valve 21 by the driving control portion 90b. The shut-off valve 21 is constantly closed during the control of the W/C hydraulic pressure.

[Processing for Controlling Pressure Increase Valve]

In control of the pressure increase valve, the estimated W/C hydraulic pressure is calculated based on a value acquired by accumulating the pressure increase valve flow amount, and the hydraulic stiffness of each of the W/Cs 9. An amount identified in advance is used as the pressure increase valve flow amount.

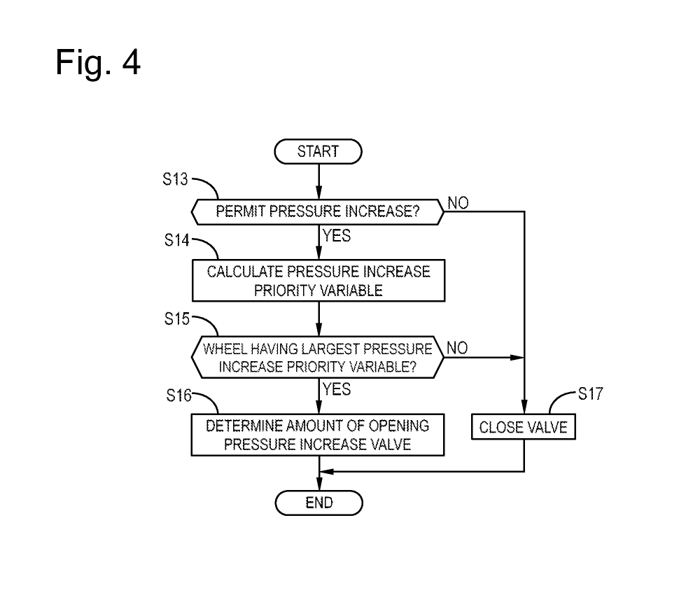

FIG. 4 is a flowchart illustrating a flow of processing for controlling the pressure increase valve according to the first embodiment.

In step S13, the ECU 90 determines whether to permit an increase in the pressure of each of the wheels FL to RR. If the determination in step S13 is YES, the processing proceeds to step S14. If the determination in step S13 is NO, the processing proceeds to step S17. At this time, the ECU 90 permits the increase in the pressure if the following equation (1) is satisfied, when Pwctg, Pwcest, and dP_inc_permt_th are defined to represent the target W/C hydraulic pressure, the estimated W/C hydraulic pressure, and a threshold value of the hydraulic pressure for permitting the control of the pressure increase valve.

Pwctg[wheel]−Pwcest[wheel]>dP_inc_permt_th[wheel] (1)

Wheel=the front left wheel FL, the front right wheel FR, the rear left wheel RL, or the rear right wheel RR

In this equation, the threshold value may be set to dP_inc_permt_th=0. This leads to a reduction in an amount of opening the pressure increase valve when opening the pressure increase valve once, and therefore can reduce dP_UPPER_ERROR_MAX.

In step S14, the ECU 90 acquires a pressure increase priority variable WC_weight of each of the wheels FL to RR from the following equation (2), when Awcg and WC_weight are defined to represent a hydraulic pressure-deceleration conversion coefficient and a pressure increase priority variable, respectively.

WC_weight[Wheel]=(Pwctg[wheel]−Pwcest[wheel])*Awctg[wheel] (2)

Wheel=the front left wheel FL, the front right wheel FR, the rear left wheel RL, or the rear right wheel RR

In step S15, the ECU 90 determines for each of the wheels FL to RR whether this wheel is a wheel having the largest variable WC_weight. If the determination in step S15 is YES, the processing proceeds to step S16. If the determination in step S15 is NO, the processing proceeds to step S17.

In step S16, the ECU 90 determines the amount of opening the pressure increase valve from (the target W/C hydraulic pressure−the estimated W/C hydraulic pressure) and (the upstream hydraulic pressure−the estimated W/C hydraulic pressure) and controls the pressure increase valve 22 with respect to the wheel having the largest variable WC_weight. As the number of pressure increase valves 22 opened simultaneously increases, dP_UPPER_ERROR increases. The increase in dP_UPPER_ERROR raises a necessity of further increasing the target upstream hydraulic pressure. Therefore, opening the pressure increase valve 22 of only the wheel having the highest pressure increase priority allows the wheel having the highest pressure increase priority to be switched per sampling cycle and thus allows the pressure increase valve 22 to be opened in order, starting from the wheel having the highest pressure increase priority. Due to this effect, the brake apparatus can reduce dP_UPPER_ERROR, thereby preventing the upstream hydraulic pressure from excessively increasing. Further, the brake apparatus can reduce the number of rotations of the motor, thereby reducing power consumed by the motor 20.

In step S17, the ECU 90 closes the pressure increase valves 22 with respect to wheels other than the wheel having the largest variable WC_weight. The method for controlling the pressure increase valve is executed by fully opening/fully closing control.

The pressure increase valve 22 is opened in descending order of the pressure increase priority in the flowchart illustrated in FIG. 4, but a plurality of pressure increase valves 22 may be opened simultaneously. In this case, the ECU 90 acquires a maximum upstream hydraulic pressure reduction amount dP_UPPER_ERROR_MAX2 when each of the pressure increase valves 22 is opened simultaneously, and uses dP_UPPER_ERROR_MAX2 in place of the above-described amount dP_UPPER_ERROR_MAX.

[Function of Control of Upstream Hydraulic Pressure]

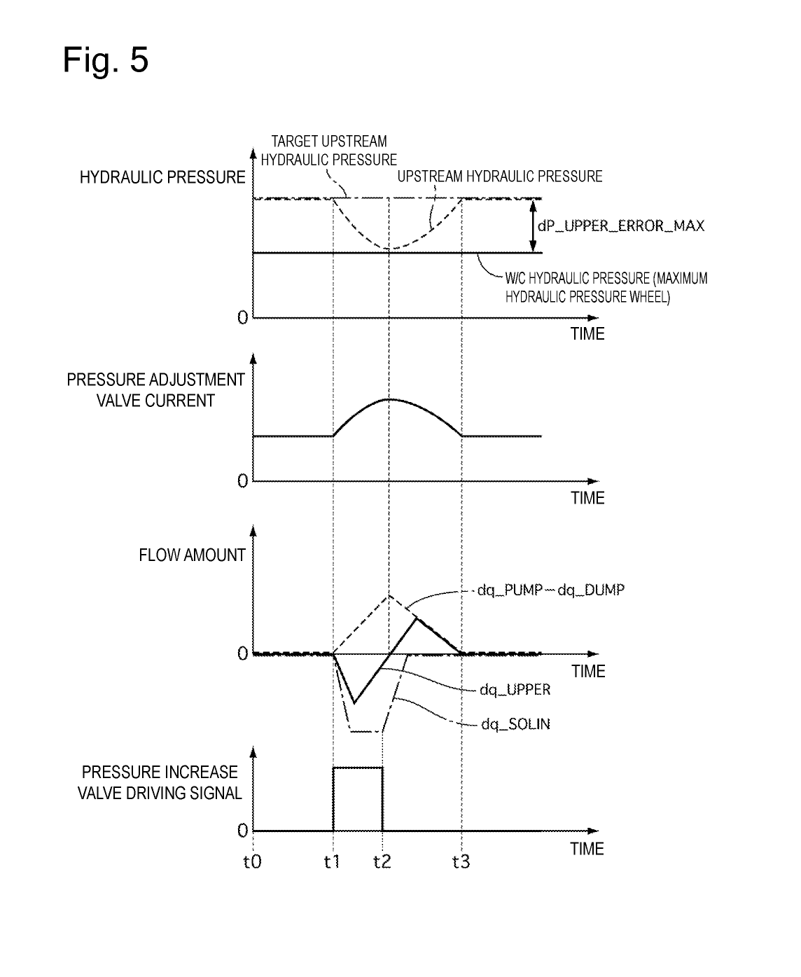

FIG. 5 is a timing chart illustrating a function of the control of the upstream hydraulic pressure according to the first embodiment.

When dq_SOLIN(≤0), dq_DUMP(≤0), dq_PUMP(≤0), and dq_UPPER are defined to represent a pressure increase valve added flow amount of each of the pressure increase valves 22, the pressure adjustment valve flow amount, a pump flow amount, and an upstream oil passage flow amount, dq_UPPER is expressed by the following equation (3).

dq_UPPER=dq_PUMP+dq_DUMP+dq_SOLIN (3)

If dq_UPPER has a positive value, the fluid amount in the upstream oil passage increases and the upstream hydraulic pressure increases. On the other hand, if dq_UPPER has a negative value, the fluid amount in the upstream oil passage reduces and the upstream hydraulic pressure reduces.

During a period from time t0 to time t1, the ECU 90 opens the pressure adjustment valve 24 to allow the pump flow amount to be transmitted therethrough. At this time, the flow amounts are dq_PUMP+dq_DUMP=0 and dq_SOLIN=0, and therefore the upstream oil passage flow amount is calculated to be dq_UPPER=0 in the equation (3), which means that the upstream hydraulic pressure is kept constant.

At time t1, the ECU 90 turns on a pressure increase valve driving signal (an opening instruction) directed to each of wheels corresponding to a target W/C hydraulic pressure having a value other than the target W/C hydraulic pressure maximum value, i.e., wheels (other than the maximum hydraulic pressure wheel) that are not the wheel corresponding to the maximum W/C hydraulic pressure (the maximum hydraulic pressure wheel). During a period from time t1 to time t2, dq_SOLIN is generated. Further, the difference between the target upstream hydraulic pressure and the upstream hydraulic pressure increases, so that the ECU 90 increases the pressure adjustment valve current to control the pressure adjustment valve 24 in the closing direction. Because the value of dq_SOLIN is large although dq_PUMP+dq_DUMP is gradually increasing, dq_UPPER has a negative value and the upstream hydraulic pressure reduces. At this time, if the upstream hydraulic pressure falls below the target W/C hydraulic pressure maximum value, the W/C hydraulic pressure of the maximum hydraulic pressure wheel temporality falls below the target W/C hydraulic pressure maximum value, which makes it impossible to acquire the vehicle deceleration requested by the driver.

Therefore, in the first embodiment, the target upstream hydraulic pressure is set to the value acquired by adding the maximum upstream hydraulic pressure reduction amount dP_UPPER_ERROR_MAX, which is the maximum value of the difference (dP_UPPER_ERROR) between the target upstream hydraulic pressure and the upstream hydraulic pressure, to the target W/C hydraulic pressure maximum value. In other words, the target upstream hydraulic pressure is raised by an assumed largest upstream hydraulic pressure reduction amount. By this setting, even when the upstream hydraulic pressure is used to increase a pressure other than the maximum hydraulic pressure wheel, the brake apparatus can prevent the upstream hydraulic pressure from falling below the target W/C hydraulic pressure maximum value, thereby achieving the target W/C hydraulic pressure at each of the wheels FL to RR.

At time t2, the ECU 90 turns off the pressure increase valve driving signal directed to the pressure increase valve (a closing instruction). The flow amount dq_SOLIN gradually approaches zero. The difference between the target upstream hydraulic pressure and the upstream hydraulic pressure increases, so that the ECU 90 increases the pressure adjustment valve current to control the pressure adjustment valve 24 in the closing direction, by which dq_PUMP+dq_DUMP gradually increases similarly to the period from time t1 to time t2. When dq_PUMP+dq_DUMP reaches |dq_PUMP+dq_DUMP|>|dq_SOLIN|, the value of dq_UPPER is turned into a positive value, and the upstream hydraulic pressure starts increasing.

At time t3, the target upstream hydraulic pressure=the upstream hydraulic pressure is established, so that, in a period from time t3, dq_PUMP+dq_DUMP and dq_SOLIN have the same values as the values during the period from t0 to time t1.

[Improvement of Accuracy of Control of W/C Hydraulic Pressure]

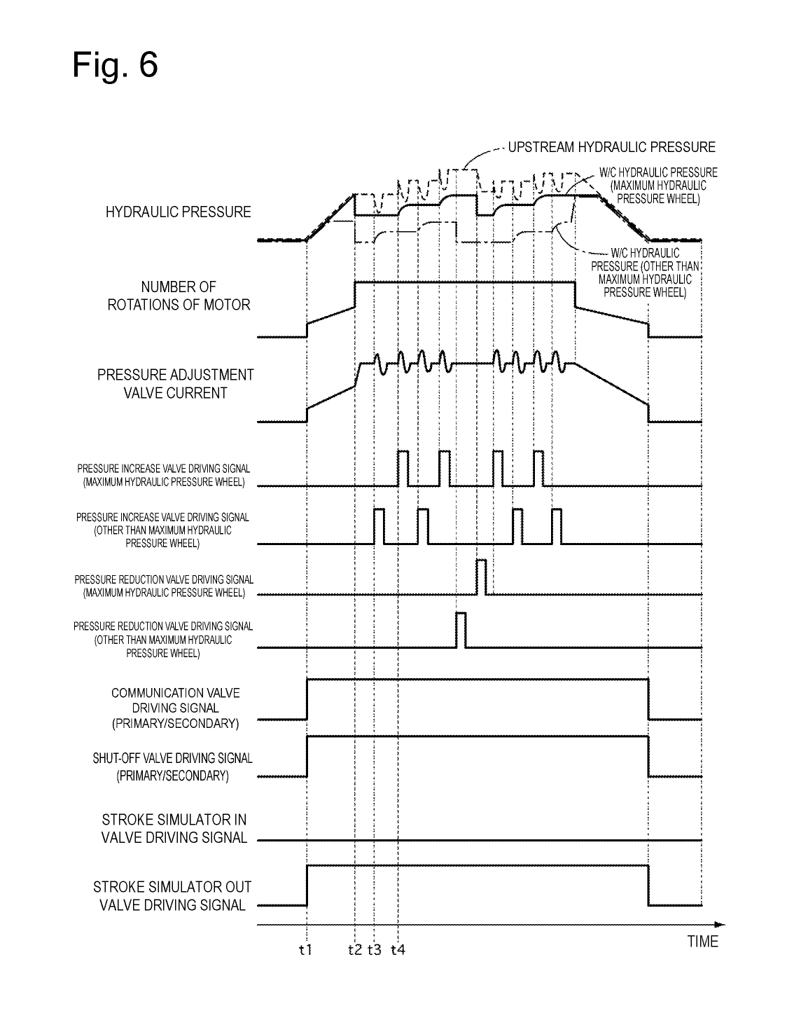

FIG. 6 is a timing chart when the ABS control is actuated on all of the wheels during the boosting control according to the first embodiment. The vehicle is running on a low μ road. The W/C hydraulic pressures other than the maximum W/C hydraulic pressure are expressed as if all of them are equal to one another for convenience in FIG. 6, but a similar effect can be acquired even when they are individually controlled.

At time t1, the driver starts pressing the brake pedal 100, and therefore the ECU 90 starts the boosting control. In the boosting control, the ECU 90 controls the shut-off valves 21 in the closing directions, the communication valves 23 in the opening directions, the stroke simulator OUT valve 28 in the opening direction, and the pressure adjustment valve 24 in the closing direction, and also actuates the pump 3 by driving the motor 20. In the boosting control, the ECU 90 determines the target W/C hydraulic pressure (the same value for each of the wheels FL to RR) according to the stroke of the brake pedal 100, and sets the target upstream hydraulic pressure to the target W/C hydraulic pressure. The ECU 90 controls the number of rotations of the motor and an opening degree of the pressure adjustment valve 24 so as to eliminate the difference between the target upstream hydraulic pressure and the upstream hydraulic pressure.

At time t2, the ABS control is actuated on all of the wheels. In the ABS control, the ECU 90 determines the target W/C hydraulic pressure of each of the wheels FL to RR in such a manner that a slip rate of each of the wheels FL to RR matches the target slip rate. In the ABS control, in the case where the ECU 90 individually controls the W/C hydraulic pressure of each of the wheels FL to RR, the ECU 90 controls the pressure increase valve 22 of the control target wheel in the opening direction when increasing the pressure, controls the pressure increase valve 22 of the control target wheel in the closing direction when maintaining the pressure, and controls the pressure increase valve 22 of the control target wheel in the closing direction and also controls the pressure reduction valve 25 in the opening direction when reducing the pressure. A difference is generated between the target W/C hydraulic pressures of the individual wheels FL to RR due to the intervention of the ABS control, and therefore the ECU 90 sets the target upstream hydraulic pressure to the value acquired by adding the maximum upstream hydraulic pressure reduction amount dP_UPPER_ERROR_MAX to the target W/C hydraulic pressure maximum value. The ECU 90 controls the number of rotations of the motor and the opening degree of the pressure adjustment valve 24 so as to eliminate the difference between the target upstream hydraulic pressure and the upstream hydraulic pressure.

At time t3, with the aim of increasing the pressure of each of the wheels other than the maximum hydraulic pressure wheel, the ECU 90 turns on the pressure increase valve signal directed to the pressure increase valve 22 of this wheel to open the pressure increase valve 22. At this time, the upstream hydraulic pressure reduces due to consumption of the upstream hydraulic pressure to increase the W/C hydraulic pressure of this wheel, but the upstream hydraulic pressure is raised relative to the target W/C hydraulic pressure maximum value by the maximum upstream hydraulic pressure reduction amount dP_UPPER_ERROR_MAX according to the opening of the pressure increase valve 22, and therefore the W/C hydraulic pressure of the maximum hydraulic pressure wheel does not fall below the target W/C hydraulic pressure.

At time t4, the target W/C hydraulic pressure of the maximum hydraulic pressure wheel increases, so that the ECU 90 turns on the pressure increase valve signal directed to the pressure increase valve 22 of the maximum hydraulic pressure wheel to open the pressure increase valve 22. At this time, the target upstream hydraulic pressure also increases according to the increase in the target W/C hydraulic pressure maximum value.

The brake apparatus according to the first embodiment is a so-called brake-by-wire system, which realizes the target W/C hydraulic pressure of each of the wheels FL to RR by closing the shut-off valve 21 to block the flow of the brake fluid between the M/C 5 and each of the W/Cs 9 and using the brake fluid pressurized by the pump 3 at the time of normal braking (at the time of the boosting control) that generates the braking force according to an amount of the brake operation performed by the driver. At the time of the normal braking, the ECU 90 sets the target W/C hydraulic pressure of each of the wheels FL to RR according to the stroke of the brake pedal 100, and controls the motor 20 driving the pump 3 and the pressure adjustment valve 24 in such a manner that the upstream hydraulic pressure of the pressure adjustment valve 24 matches the target upstream hydraulic pressure according to the target W/C hydraulic pressure. When the ABS control is actuated from this state, the target W/C hydraulic pressure of the control target wheel is set to a value according to the target slip rate, and the ECU 90 increases/reduces or maintains the W/C hydraulic pressure by the pressure increase valve 22 and/or the pressure reduction valve 25 in such a manner that the slip rate of the control target wheel matches the target slip rate. In other words, while the motor 20 and the pressure adjustment valve 24 operate according to the target upstream hydraulic pressure determined from the target W/C hydraulic pressure maximum value, the pressure increase valve 22 and the pressure reduction valve 25 operate according to the slip state of the wheel independently of the target upstream hydraulic pressure. As a result, when the pressure increase valve 22 of each of the wheels other than the maximum hydraulic pressure wheel is opened, this opening causes such a phenomenon that the W/C hydraulic pressure of the maximum hydraulic pressure wheel temporarily falls below the target W/C hydraulic pressure maximum value due to the consumption of the upstream hydraulic pressure to increase the pressure of each of the wheels other than the maximum hydraulic pressure wheel. A conventional brake apparatus in which the master cylinder and the wheel cylinders are constantly connected to each other is not subject to the above-described problem even when the pressure increase valve of each of the wheels other than the maximum hydraulic pressure wheel is opened, because a sufficiently high W/C hydraulic pressure is generated due to the brake operation performed by the driver during the ABS control. Now, examples of conceivable measures include preventing or cutting down the reduction in the upstream hydraulic pressure by increasing the number of rotations of the motor when the upstream hydraulic pressure reduces, and excessively increasing the number of rotations of the motor since the normal braking is carried out before the intervention of the ABS control. However, the pump has high inertia and cannot reach the targeted number of rotations immediately, so that the reduction in the W/C hydraulic pressure of the maximum hydraulic pressure wheel cannot be avoided by the former method. Further, the brake-by-wire system constantly drives the motor during the braking, so that the latter method raises problems of increases in motor noise and power consumption at the time of the normal control.

On the other hand, in the brake control according to the first embodiment, the brake apparatus determines whether the difference between the target W/C maximum value and the target W/C minimum value exceeds the predetermined value after calculating the target W/C hydraulic pressure of each of the W/Cs 9. Then, the brake apparatus sets the target upstream hydraulic pressure to the value acquired by adding the maximum upstream hydraulic pressure reduction amount dP_UPPER_ERROR_MAX to the target W/C hydraulic pressure maximum value if the difference exceeds the predetermined value, and sets the target upstream hydraulic pressure to the target W/C hydraulic pressure if the difference is the predetermined value or smaller. By this method, the brake apparatus can prevent or cut down the reduction in the W/C hydraulic pressure at the maximum hydraulic pressure wheel when the pressure increase valve 22 of each of the wheels other than the maximum hydraulic pressure wheel is opened in the ABS control, the TCS control, and the brake control for controlling the motion of the vehicle, in which the difference is generated between the individual target W/C hydraulic pressures. As a result, the brake apparatus can achieve the target W/C hydraulic pressure at each of the wheels FL to RR, thereby improving the accuracy of the control of the W/C hydraulic pressure. Further, in the first embodiment, the brake apparatus opens the pressure increase valve 22 in order starting from the pressure increase valve 22 having the highest pressure increase priority without opening the plurality of pressure increase valves 22 simultaneously in the control of the pressure increase valve. By this operation, the brake apparatus can reduce dP_UPPER_ERROR_MAX, thereby reducing the number of rotations of the motor and thus reducing the power consumption of the motor 20. On the other hand, the brake apparatus sets the target upstream hydraulic pressure to a required minimum value (the target W/C hydraulic pressure) at the time of the normal braking (at the time of the boosting control) in which each of the target W/C hydraulic pressures is equal to one another), and therefore can avoid the increases in the motor noise and the power consumption at the time of the normal braking.

In the first embodiment, the following advantageous effects can be acquired.

(1) The brake apparatus includes the first brake circuit (the supply oil passage 73, the M/C pipes 10M, and the supply oil passages 11) connecting the M/C 5 configured to generate the brake hydraulic pressure according to the pedal operation and the W/Cs 9 configured to generate the braking force on each of the wheels FL to RR of the vehicle by the application of the brake hydraulic pressure, the pump 3 configured to increase the pressure of the brake fluid in the M/C 5 and transmit this brake fluid to the W/Cs 9 via the second brake circuit (the discharge oil passage 13) connected to the first brake circuit, the pressure increase valves 22 provided in the first brake circuit (the oil passage 11a, the oil passage 11b, the oil passage 11c, and the oil passage 11d) on the W/C 9 side with respect to the portion where the first brake circuit and the second brake circuit are connected to each other, and the first target upstream hydraulic pressure calculation portion 90c configured to calculate the target hydraulic pressure in the second brake circuit (the target upstream hydraulic pressure) in such a manner that this target hydraulic pressure exceeds the maximum value of the target W/Cs of the individual wheels FL to RR (the target W/C hydraulic pressure maximum value) by the amount of the change in the hydraulic pressure in the second brake circuit when the pressure increase valve 22 corresponding to the wheel other than the maximum hydraulic pressure wheel is opened (the maximum upstream hydraulic pressure reduction amount dP_UPPER_ERROR_MAX).

Therefore, the brake apparatus can prevent or cut down the reduction in the W/C hydraulic pressure at the maximum hydraulic pressure wheel when the pressure increase valve 22 corresponding to the wheel other than the maximum hydraulic pressure wheel is opened, thereby improving the control accuracy of the control of the W/C hydraulic pressure.

(2) The brake apparatus further includes the target W/C hydraulic pressure comparison portion 90e configured to determine whether the difference between the maximum value and the minimum value of the target W/C hydraulic pressures of the individual wheels FL to RR exceeds the predetermined value, and the second target upstream hydraulic pressure calculation portion 90d configured to set the target W/C hydraulic pressure as the target hydraulic pressure in the second brake circuit if the difference is the predetermined value or smaller. The first target upstream hydraulic pressure calculation portion 90c calculates the target hydraulic pressure in the second brake circuit if the difference exceeds the predetermined value.

The brake apparatus does not open the pressure increase valve 22 when the target W/C hydraulic pressure of each of the wheels FL to RR is approximately equal to one another, and therefore can avoid the increases in the motor noise and the power consumption by setting the target W/C hydraulic pressure as the target hydraulic pressure in the second brake circuit.

(3) The brake apparatus further includes the hydraulic pressure detection portion (the W/C hydraulic pressure sensors 92 and the discharge pressure sensor 93) configured to detect the hydraulic pressure in the second brake circuit, the fourth brake circuit (the pressure adjustment oil passage 14, the reservoir 120, and the intake oil passage 12) connecting the second brake circuit and the intake side of the pump 3, the pressure adjustment valve 24 provided in the fourth brake circuit, and the hydraulic pressure feedback compensator 95a configured to calculate the amount of controlling the pressure adjustment valve 24 (the target pressure adjustment valve current) by the feedback calculation based on the difference between the hydraulic pressure detected by the hydraulic pressure detection portion and the target hydraulic pressure (the target upstream hydraulic pressure−the upstream hydraulic pressure).

Therefore, the brake apparatus can eliminate or reduce an influence of an (unknown) disturbance appearing in the amount of controlling the pressure adjustment valve 24 by the feedback control, thereby controlling the pressure adjustment valve 24 in such a manner that the hydraulic pressure in the second brake circuit matches the target hydraulic pressure. Further, the brake apparatus can control the hydraulic pressure in the second brake circuit highly responsively within the range that does not cause the feedback control system to diverge, by adjusting the feedback gains Kp, Ki, and Kd by the hydraulic pressure feedback compensator 95a.

(4) The brake apparatus includes the fluid passage of the primary system (the supply oil passage 73P, the primary pipe 10MP, the supply oil passage 11P, the oil passage 11a, and the oil passage 11d) including the plurality of W/Cs 9FL and 9RR in which the pressure can be increased by the M/C hydraulic pressure generated in the primary chamber 50P of the M/C 5 configured to generate the brake hydraulic pressure according to the pedal operation, the fluid passage of the secondary system (the supply oil passage 73S, the secondary pipe 10MS, the supply oil passage 11S, the oil passage 11b, and the oil passage 11c) including the plurality of W/Cs 9FR and 9RL in which the pressure can be increased by the M/C hydraulic pressure generated in the secondary chamber 50S of the M/C 5, the communication fluid passage (the oil passage 13P and the oil passage 13S) connecting the fluid passage of the primary system and the fluid passage of the secondary system, the pump 3 configured to discharge the brake fluid to the communication fluid passage, the pressure increase valves 22 respectively provided in the fluid passages (the oil passage 11a, the oil passage 11b, the oil passage 11c, and the oil passage 11d) on the W/C 9 side with respect to the portion where the communication fluid passage and the fluid passages of the primary system and the secondary system are connected to each other, and the first target upstream hydraulic pressure calculation portion 90c configured to calculate the target hydraulic pressure in the communication fluid passage (the target upstream hydraulic pressure) in such a manner that this target hydraulic pressure exceeds the maximum value of the target W/C hydraulic pressures of the individual wheels FL to RR (the target W/C hydraulic pressure maximum value) by the amount of the change in the hydraulic pressure in the communication fluid passage when the pressure increase valve 22 corresponding to the wheel other than the maximum hydraulic pressure wheel is opened (the maximum upstream hydraulic pressure reduction amount dP_UPPER_ERROR_MAX).

Therefore, the brake apparatus can prevent or cut down the reduction in the W/C hydraulic pressure at the maximum hydraulic pressure wheel when the pressure increase valve 22 corresponding to the wheel other than the maximum hydraulic pressure wheel is opened, thereby improving the control accuracy of the control of the W/C hydraulic pressure.

(5) The brake apparatus includes the return flow fluid passage (the pressure adjustment oil passage 14, the reservoir 120, and the intake oil passage 12) branching from the communication fluid passage between the fluid passage of the primary system and the fluid passage of the secondary system and configured to return the brake fluid discharged into the communication fluid passage to the intake side of the pump 3, and the pressure adjustment valve 24 provided in the return flow fluid passage.

Therefore, the brake apparatus can realize the target hydraulic pressure in the communication fluid passage by controlling the opening degree of the pressure adjustment valve 24 to adjust the flow amount of the brake fluid flowing through the pressure adjustment valve 24.

(6) The brake apparatus further includes the primary shut-off valve 21P provided in the fluid passage 11P on the M/C 5 side with respect to the portion where the communication fluid passage and the primary system are connected to each other, and the secondary shut-off valve 21S provided in the fluid passage 11S on the M/C 5 side with respect to the portion where the communication fluid passage and the secondary system are connected to each other.

Therefore, the brake apparatus can realize the so-called brake-by-wire system, which realizes the target W/C hydraulic pressure of each of the wheels FL to RR by closing both the shut-off valves 21P and 21S to block the flow of the brake fluid between the M/C 5 and each of the W/Cs 9 and using the brake fluid pressurized by the pump 3.

(7) The brake control method is the brake control method for the brake apparatus including the first brake circuit (the supply oil passage 73, the M/C pipe 10M, and the supply oil passages 11) connecting the M/C 5 configured to generate the brake hydraulic pressure according to the pedal operation and the W/Cs 9 configured to generate the braking force on each of wheels FL to RR of the vehicle by the application of the brake hydraulic pressure, the pump 3 configured to increase the pressure of the brake fluid in the M/C 5 and transmit this brake fluid to the W/Cs 9 via the second brake circuit (the discharge oil passage 13) connected to the first brake circuit, and the pressure increase valves 22 provided in the first brake circuit (the oil passage 11a, the oil passage 11b, the oil passage 11c, and the oil passage 11d) on the W/C 9 side with respect to the portion where the first brake circuit and the second brake circuit are connected to each other. The brake control method includes a target W/C hydraulic pressure calculation step of calculating the target W/C hydraulic pressure of each of the wheels FL to RR based on the state of the vehicle, and a first target upstream hydraulic pressure calculation step of calculating the target hydraulic pressure in the second brake circuit (the target upstream hydraulic pressure) in such a manner that this target hydraulic pressure exceeds the maximum value of the individual target W/C hydraulic pressures (the target W/C hydraulic pressure maximum value) by the amount of the change in the hydraulic pressure in the second brake circuit when the pressure increase valve 22 corresponding to the wheel other than the maximum hydraulic pressure wheel is opened (the maximum upstream hydraulic pressure reduction amount dP_UPPER_ERROR_MAX).

Therefore, the brake control method can prevent or cut down the reduction in the W/C hydraulic pressure at the maximum hydraulic pressure wheel when the pressure increase valve 22 corresponding to the wheel other than the maximum hydraulic pressure wheel is opened, thereby improving the control accuracy of the control of the W/C hydraulic pressure.

(8) The brake control method further includes a target W/C hydraulic pressure comparison step of determining whether the difference between the maximum value and the minimum value of the target W/C hydraulic pressures of the individual wheels FL to RR exceeds the predetermined value as, and a second target upstream hydraulic pressure calculation step of setting the target W/C hydraulic pressure as the target hydraulic pressure in the second brake circuit if the difference is the predetermined value or smaller. The first target upstream hydraulic pressure calculation step includes calculating the target hydraulic pressure in the second brake circuit if the difference exceeds the predetermined value.

The brake control method does not open the pressure increase valve 22 when the target W/C hydraulic pressure of each of the wheels FL to RR is approximately equal to one another, and therefore can avoid the increases in the motor noise and the power consumption by setting the target W/C hydraulic pressure as the target hydraulic pressure in the second brake circuit.

### Second Embodiment

Next, a second embodiment will be described. The second embodiment has a basic configuration similar to the first embodiment, and therefore will be described focusing on only differences therefrom.

### [Processing for Calculating Target Upstream Hydraulic Pressure]

Processing for controlling the W/C hydraulic pressure according to the second embodiment is different from the first embodiment in terms of the method for calculating the target upstream hydraulic pressure in step S3 illustrated in FIG. 3.

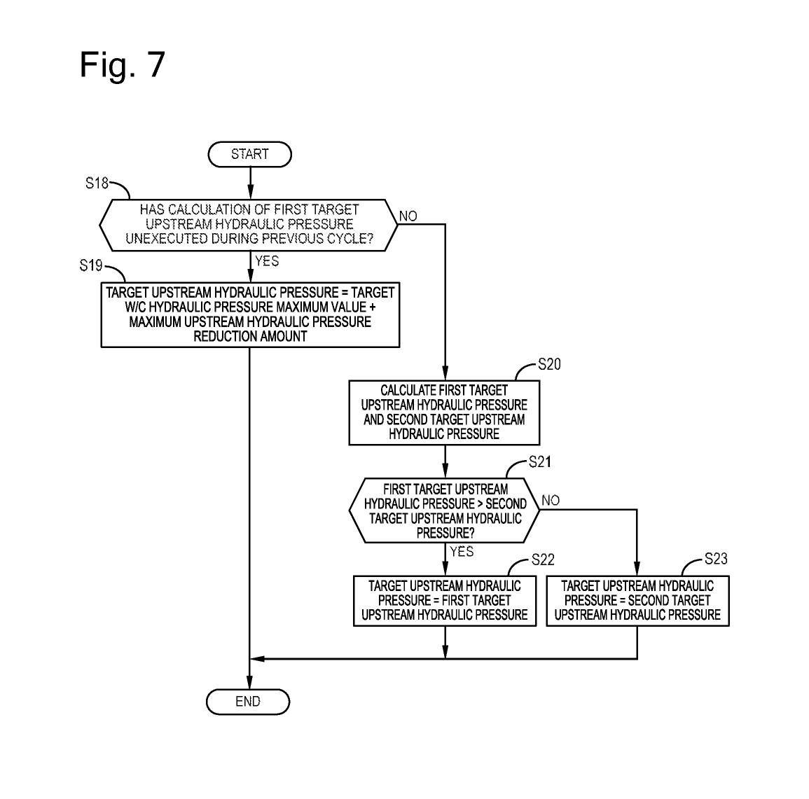

FIG. 7 is a flowchart illustrating a flow of the processing for calculating the target upstream hydraulic pressure according to the second embodiment.

In step S18, the ECU 90 determines whether a calculation of a first target upstream hydraulic pressure has been unexecuted during the previous sampling cycle. If the determination in step S18 is YES, the processing proceeds to step S19. If the determination in step S18 is NO, the processing proceeds to step S20.

In step S19, the ECU 90 sets the target upstream hydraulic pressure to the value acquired by adding the maximum upstream hydraulic pressure reduction amount dP_UPPER_ERROR_MAX to the target W/C hydraulic pressure maximum value. At this time, the target upstream hydraulic pressure may be set to a value acquired by adding a predetermined amount a larger than dP_UPPER_ERROR_MAX in place of dP_UPPER_ERROR_MAX. A value that does not affect a sound and a vibration is used as the predetermined amount α.

In step S20, the ECU 90 calculates the first target upstream hydraulic pressure (a first target hydraulic pressure) and a second target upstream hydraulic pressure (a second target hydraulic pressure). The first target upstream hydraulic pressure is set to a value acquired by subtracting a predetermined amount (the upstream hydraulic pressure reduction amount) from the target upstream hydraulic pressure in the previous sampling cycle (a target upstream hydraulic pressure previous value). The second target upstream hydraulic pressure is set to a value acquired by adding the maximum upstream hydraulic pressure reduction amount dP_UPPER_ERROR_MAX to the target W/C hydraulic pressure maximum value.

In step S21, the ECU 90 determines whether the first target upstream hydraulic pressure is higher than the second target upstream hydraulic pressure. If the determination in step S21 is YES, the processing proceeds to step S22. If the determination in step S21 is NO, the processing proceeds to step S23.

In step S22, the ECU 90 sets the target upstream hydraulic pressure to the first target upstream hydraulic pressure.

In step S23, the ECU 90 sets the target upstream hydraulic pressure to the second target upstream hydraulic pressure.

[Improvement of Accuracy of Control of W/C Hydraulic Pressure]

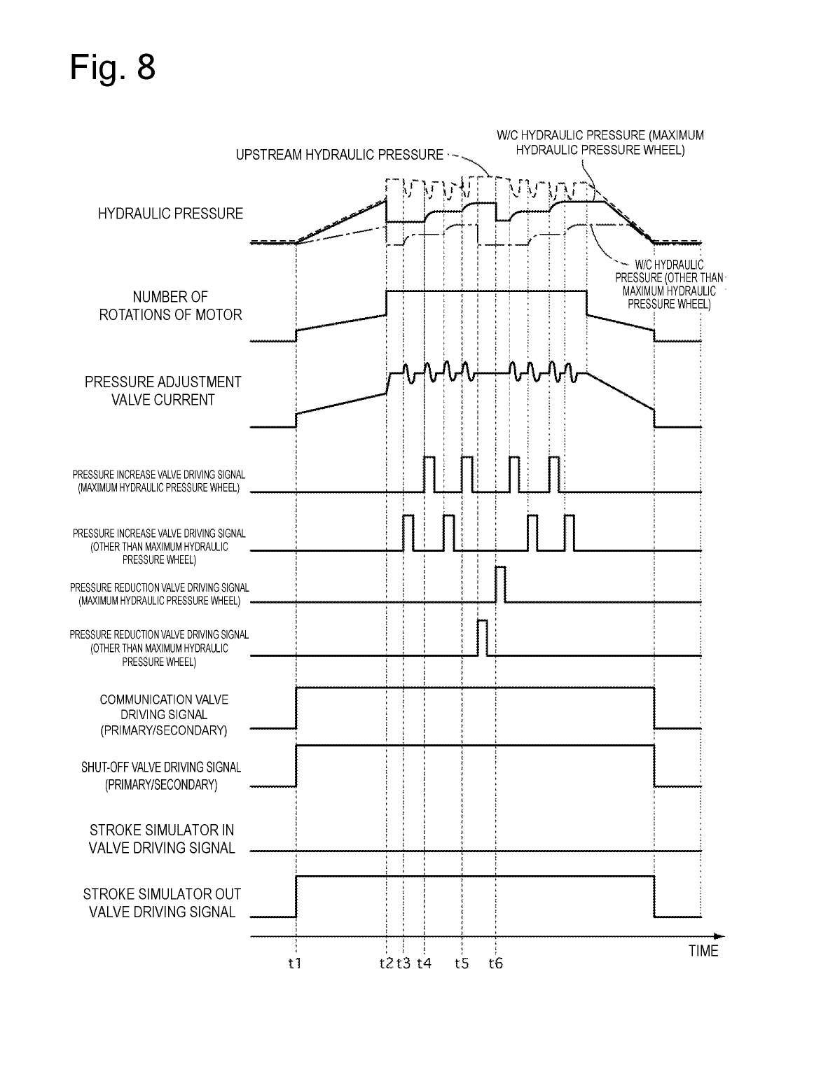

FIG. 8 is a timing chart when the ABS control is actuated on all of the wheels during the boosting control according to the second embodiment.

At time t1, the ECU 90 sets the target upstream hydraulic pressure to the target W/C hydraulic pressure.

At time t2, the ABS control is actuated on all of the wheels, and therefore the ECU 90 sets the target upstream hydraulic pressure to the value acquired by adding the predetermined amount a to the target W/C hydraulic pressure maximum value. During a period from time t2 to time t5, the first target upstream hydraulic pressure (the previous target upstream hydraulic pressure−the upstream hydraulic pressure reduction amount) is higher than the second target upstream hydraulic pressure (the target W/C hydraulic pressure maximum value+the maximum upstream hydraulic pressure reduction amount), so that the target upstream hydraulic pressure is set to the first target upstream hydraulic pressure. Therefore, the upstream hydraulic pressure gradually reduces.

At time t5, the first target upstream hydraulic pressure matches or falls below the second target upstream hydraulic pressure according to an increase in the target W/C hydraulic pressure maximum value, so that the target upstream hydraulic pressure is set to the second target upstream hydraulic pressure and therefore the upstream hydraulic pressure increases.

At time t6, the first target upstream hydraulic pressure exceeds the second target upstream hydraulic pressure according to a reduction in the target W/C hydraulic pressure maximum value, so that the target upstream hydraulic pressure is set to the first target upstream hydraulic pressure. Therefore, the upstream hydraulic pressure gradually reduces at and after time t6.

Each of the hydraulic pressure sensors 92P, 92S, and 93, which detect the upstream hydraulic pressure, operates according to a predetermined detection cycle. Therefore, when the upstream hydraulic pressure changes during the detection cycle, a deviation is generated between the recognized upstream hydraulic pressure and the actual upstream hydraulic pressure. Therefore, reducing the target upstream hydraulic pressure by the same change amount when the maximum target W/C hydraulic pressure reduces, like the first embodiment, results in a calculation of the estimated W/C hydraulic pressure with the upstream hydraulic pressure in an instable state. The reduction in accuracy of the calculation of the estimated W/C hydraulic pressure leads to a reduction in the accuracy of the control of the W/C hydraulic pressure.

Therefore, the brake apparatus according to the second embodiment sets the target upstream hydraulic pressure to the first target upstream hydraulic pressure and reduces the upstream hydraulic pressure gradually so as to follow a constant gradient, while the first target upstream hydraulic pressure exceeds the second target upstream hydraulic pressure. By this method, a sudden change in the upstream hydraulic pressure is prevented or reduced, and therefore the brake apparatus can calculate the estimated W/C hydraulic pressure with the upstream hydraulic pressure in a stable state. As a result, the brake apparatus can reduce an error of the estimated W/C hydraulic pressure from the actual W/C hydraulic pressure, thereby improving the accuracy of the control of the W/C hydraulic pressure.

In the second embodiment, the following advantageous effects can be acquired.

(9) The first target upstream hydraulic pressure calculation portion 90c calculates the first target upstream hydraulic pressure acquired by subtracting the upstream hydraulic pressure reduction amount from the previous value of the target hydraulic pressure in the second brake circuit (the target upstream hydraulic pressure previous value), and the second target upstream hydraulic pressure larger than the maximum value of the target W/C hydraulic pressures of the individual wheels FL to RR (the target W/C hydraulic pressure maximum value) by the amount of the change in the hydraulic pressure in the second brake circuit when the pressure increase valve 22 corresponding to the wheel other than the maximum hydraulic pressure wheel is opened (the maximum upstream hydraulic pressure reduction amount dP_UPPER_ERROR_MAX), and sets the larger one of the first target upstream hydraulic pressure and the second target upstream hydraulic pressure as the target hydraulic pressure in the second brake circuit (the target upstream hydraulic pressure).

Therefore, the brake apparatus can eliminate or reduce the difference between the estimated W/C hydraulic pressure and the actual W/C hydraulic pressure, thereby improving the accuracy of the control of the W/C hydraulic pressure.

(10) The first target upstream hydraulic pressure calculation step includes calculating the first target upstream hydraulic pressure acquired by subtracting the upstream hydraulic pressure reduction amount from the previous value of the target hydraulic pressure in the second brake circuit, and the second target upstream hydraulic pressure larger than the maximum value of the target W/C hydraulic pressures of the individual wheels FL to RR by the amount of the change in the hydraulic pressure in the second brake circuit when the pressure increase valve 22 corresponding to the wheel other than the maximum hydraulic pressure wheel is opened, and setting the larger one of the first target upstream hydraulic pressure and the second target upstream hydraulic pressure as the target hydraulic pressure in the second brake circuit.

Therefore, the brake control method can eliminate or reduce the difference between the estimated W/C hydraulic pressure and the actual W/C hydraulic pressure, thereby improving the accuracy of the control of the W/C hydraulic pressure.

### Third Embodiment

Next, a third embodiment will be described. The third embodiment has a basic configuration similar to the first embodiment, and therefore will be described focusing on only differences therefrom.

In the third embodiment, the driving control portion 90b controls the opening/closing of the stroke simulator IN valve 27 and the stroke simulator OUT valve 28 according to a change in a sum of the target W/C hydraulic pressures of the individual wheels FL to RR (a total value of the required brake fluid amounts) during the ABS control. When the total value of the required brake fluid amounts reduces, the driving control portion 90b controls the stroke simulator OUT valve 28 and the stroke simulator IN valve 27 in a closing direction and an opening direction, respectively. This control causes an increase in the pressure in the backpressure chamber 602 and thus an increase in the pedal reaction force, thereby resulting in a reduction in the pedal stroke. When the total value of the required brake fluid amounts increases, the driving control portion 90b controls the stroke simulator OUT valve 28 and the stroke simulator IN valve 27 in the opening direction and a closing direction, respectively. This control causes a reduction in the pressure in the backpressure chamber 602 and thus a reduction in the pedal reaction force, thereby resulting in an increase in the pedal stroke. When the total value of the required brake fluid amounts is not changed, the driving control portion 90b controls the stroke simulator OUT valve 28 and the stroke simulator IN valve 27 in the closing direction and the closing direction, respectively. This control prevents or reduces changes in the pedal reaction force and the pedal stroke, thereby keeping the brake pedal 100 at a generally constant position.

As described above, the brake apparatus appropriately controls the pedal reaction force and the pedal stroke during the ABS control, according to the total value of the required brake hydraulic pressures, thereby allowing the brake pedal 100 to be located at an appropriate position and thus succeeding in realizing a pedal feeling less uncomfortable for the driver.

When controlling the pressure increase valve 22 in the opening direction, the brake apparatus prioritizes the increase in the W/C hydraulic pressure over the pedal feeling, and refrains from opening the stroke simulator IN valve 27 even if the total value of the required brake fluid amounts reduces.

[Processing for Calculating Target Upstream Hydraulic Pressure]

Processing for controlling the W/C hydraulic pressure according to the third embodiment is different from the first embodiment in terms of the method for calculating the target upstream hydraulic pressure in step S3 illustrated in FIG. 3.

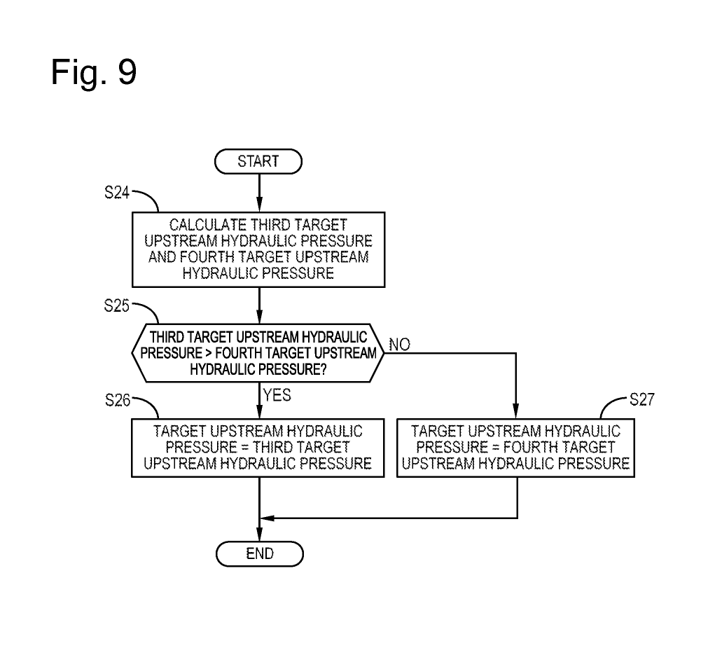

FIG. 9 is a flowchart illustrating a flow of the processing for calculating the target upstream hydraulic pressure according to the third embodiment.

In step S24, the ECU 90 calculates a third target upstream hydraulic pressure (a third target hydraulic pressure) and a fourth target upstream hydraulic pressure (a fourth target hydraulic pressure). The third upstream hydraulic pressure is set to the value acquired by adding the maximum upstream hydraulic pressure reduction amount dP_UPPER_ERROR_MAX to the target W/C hydraulic pressure maximum value. The fourth target upstream hydraulic pressure is set to a value acquired by adding to the M/C hydraulic pressure a maximum upstream hydraulic pressure reduction amount dP_UPPER_ERROR_SSin_MAX when the stroke simulator IN valve is driven. A value used as dP_UPPER_ERROR_SSin_MAX is a maximum value of a difference dP_UPPER_ERROR_SSin between the target upstream hydraulic pressure and the upstream hydraulic pressure that is generated when the stroke simulator IN valve 27 is driven.

In step S25, the ECU 90 determines whether the third target upstream hydraulic pressure is lower than the fourth target upstream hydraulic pressure. If the determination in step S25 is YES, the processing proceeds to step S26. If the determination in step S25 is NO, the processing proceeds to step S27.

In step S26, the ECU 90 sets the target upstream hydraulic pressure to the third target upstream hydraulic pressure.

In step S27, the ECU 90 sets the target upstream hydraulic pressure to the fourth target upstream hydraulic pressure.

[Function of Control of Upstream Hydraulic Pressure]

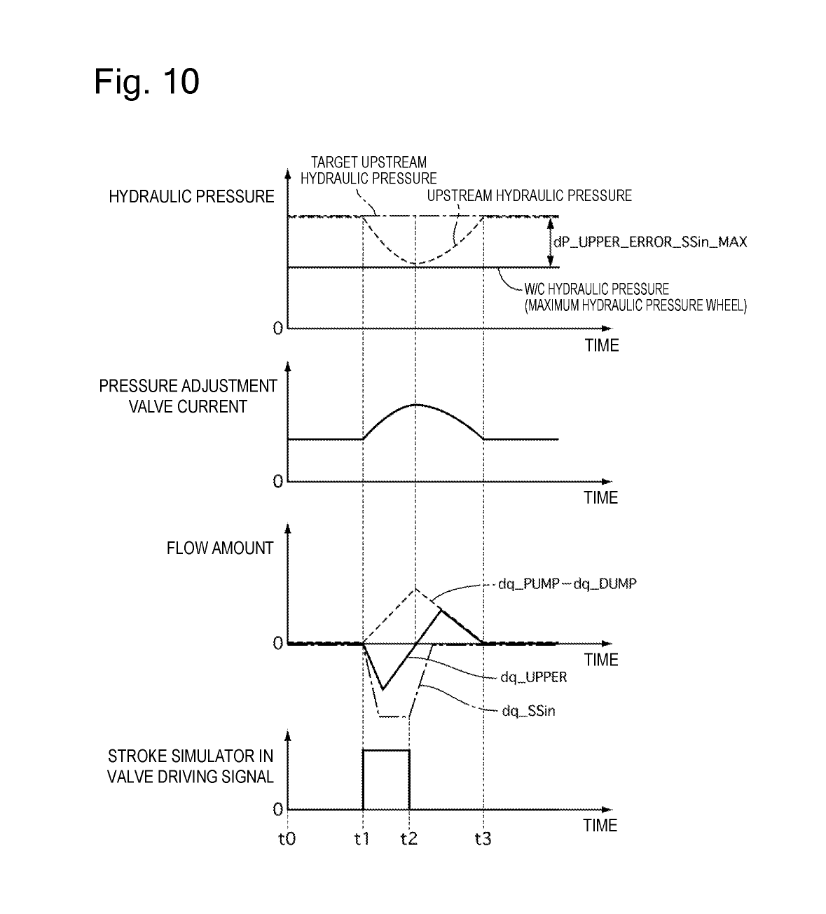

FIG. 10 is a timing chart illustrating a function of the control of the upstream hydraulic pressure according to the third embodiment.

When dq_SSin(≤0), dq_DUMP(≤0), dq_PUMP(≥0), and dq_UPPER_SSin are defined to represent a stroke simulator IN valve added flow amount of the stroke simulator IN valve 27, the pressure adjustment valve flow amount, the pump flow amount, and the upstream oil passage flow amount, dq_UPPER_SSin is expressed by the following equation (4).

dq_UPPER_SSin=dq_PUMP+dq_DUMP+dq_SSin (4)

If dq_UPPER_SSin has a positive value, the fluid amount in the upstream oil passage increases and the upstream hydraulic pressure increases. On the other hand, if dq_UPPER_SSin has a negative value, the fluid amount in the upstream oil passage reduces and the upstream hydraulic pressure reduces.

During the period from time t0 to time t1, the ECU 90 opens the pressure adjustment valve 24 to allow the pump flow amount to be transmitted therethrough. At this time, the flow amounts are dq_PUMP+dq_DUMP=0 and dq_SSin=0, and therefore the upstream oil passage flow amount is calculated to be dq_UPPER_SSin=0 in the equation (4), which means that the upstream hydraulic pressure is kept constant.

At time t1, the ECU 90 turns on a stroke simulator IN valve driving signal (an opening instruction). During the period from time t1 to time t2, dq_SSin, which is the amount of the flow passing through the stroke simulator IN valve 27, is generated. Further, the difference between the target upstream hydraulic pressure and the upstream hydraulic pressure increases, so that the ECU 90 increases the pressure adjustment valve current to control the pressure adjustment valve 24 in the closing direction. Because the value of dq_SSin is large although dq_PUMP+dq_DUMP is gradually increasing, dq_UPPER_SSin has a negative value and the upstream hydraulic pressure reduces. At this time, if the upstream hydraulic pressure falls below the target W/C hydraulic pressure maximum value, the W/C hydraulic pressure of the maximum hydraulic pressure wheel temporality falls below the target W/C hydraulic pressure maximum value, which makes it impossible to acquire the deceleration requested by the driver.

Therefore, in the third embodiment, the ECU 90 acquires the target upstream hydraulic pressure by selecting a higher one of the third target upstream hydraulic pressure, which is the value calculated by adding the maximum upstream hydraulic pressure reduction amount dP_UPPER_ERROR_MAX to the target W/C hydraulic pressure maximum value, and the fourth target upstream hydraulic pressure, which is the value calculated by adding the maximum upstream hydraulic pressure reduction amount dP_UPPER_ERROR_SSin_MAX when the stroke simulator IN valve is driven to the M/C hydraulic pressure. By this method, the brake apparatus can prevent the upstream hydraulic pressure from falling below the target W/C hydraulic pressure maximum value even when the stroke simulator IN valve 27 is opened during the ABS control, thereby realizing the target W/C hydraulic pressure at each of the wheels FL to RR.

At time t2, the ECU 90 turns off the stroke simulator IN valve driving signal. The flow amount Dq_SSin gradually approaches zero. The difference between the target upstream hydraulic pressure and the upstream hydraulic pressure increases, so that the ECU 90 increases the pressure adjustment valve current to control the pressure adjustment valve 24 in the closing direction, and dq_PUMP+dq_DUMP gradually increases similarly to the period from time t1 to time t2. When dq_PUMP+dq_DUMP reaches |dq_PUMP+dq_DUMP|>|dq_SSin|, the value of dq_SSin is turned into a positive value, and the upstream hydraulic pressure starts increasing.

At time t3, the target upstream hydraulic pressure=the upstream hydraulic pressure is established, so that, in the period from time t3, dq_PUMP+dq_DUMP and dq_SSin have the same values as the values during the period from time t0 to time t1.

[Improvement of Accuracy of Control of W/C Hydraulic Pressure]

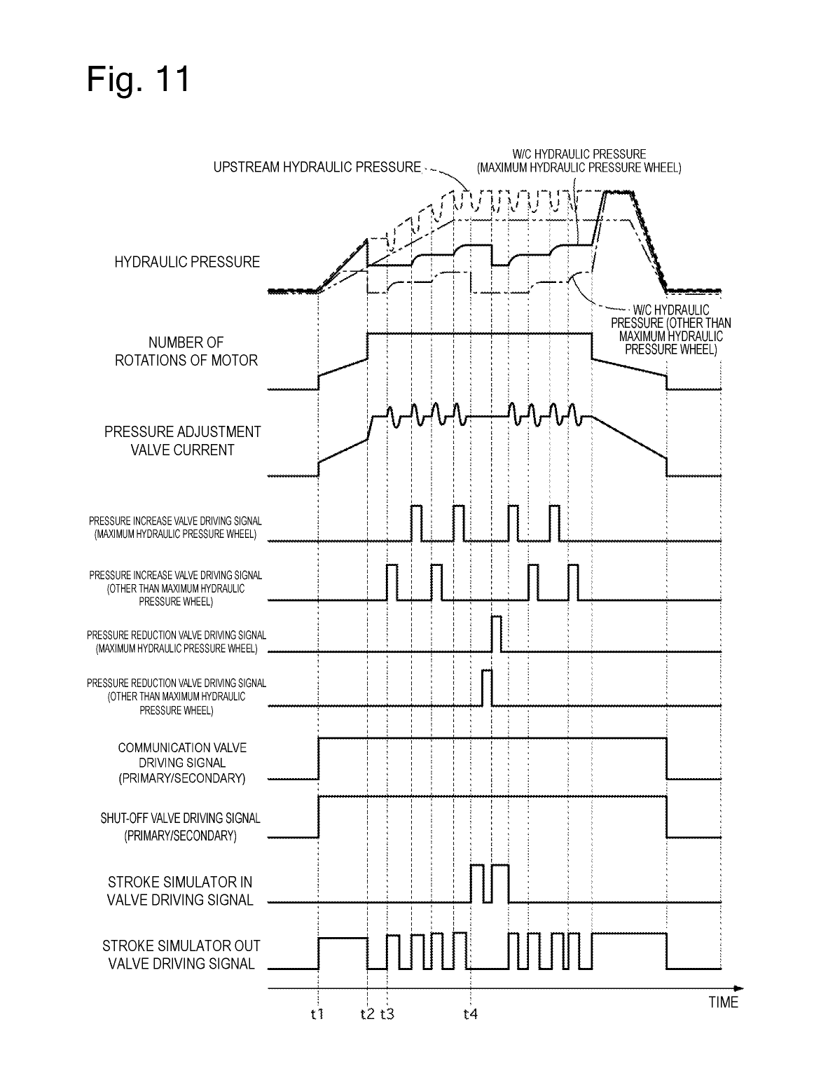

FIG. 11 is a timing chart when the ABS control is actuated on all of the wheels during the boosting control according to the third embodiment.

At time t1, the ECU 90 sets the target upstream hydraulic pressure to the target W/C hydraulic pressure.

At time t2, the ABS control is actuated on all of the wheels, and therefore the ECU 90 sets the target upstream hydraulic pressure to the value acquired by adding the maximum upstream hydraulic pressure reduction amount dP_UPPER_ERROR_MAX to the target W/C hydraulic pressure maximum value.

At time t3, the fourth target upstream hydraulic pressure (the W/C hydraulic pressure+the maximum upstream hydraulic pressure reduction amount when the stroke simulator IN valve is driven) exceeds the third target upstream hydraulic pressure (the target W/C hydraulic pressure maximum value+the maximum upstream hydraulic pressure reduction amount) due to the increase in the M/C hydraulic pressure, so that the target upstream hydraulic pressure is set to the fourth target upstream hydraulic pressure. The upstream hydraulic pressure increases according to the increase in the M/C hydraulic pressure. Further, the total value of the required brake fluid amounts increases, so that the ECU 90 controls the stroke simulator OUT valve 28 in the opening direction. Further, with the aim of increasing the pressure of each of the wheels other than the maximum hydraulic pressure wheel, the ECU 90 turns on the pressure increase valve signal directed to the pressure increase valve 22 of this wheel to open the pressure increase valve 22. At this time, the upstream hydraulic pressure reduces due to the consumption of the upstream hydraulic pressure to increase the W/C hydraulic pressure of this wheel, but the upstream hydraulic pressure is raised relative to the target W/C hydraulic pressure maximum value by the maximum upstream hydraulic pressure reduction amount dP_UPPER_ERROR_SSin_MAX when the stroke simulator IN valve is driven, which is larger than the maximum upstream hydraulic pressure reduction amount dP_UPPER_ERROR_MAX accompanying the opening of the pressure increase valve 22, and therefore the W/C hydraulic pressure of the maximum hydraulic pressure wheel does not fall below the target W/C hydraulic pressure.

At time t4, the total value of the required brake fluid amounts reduces, so that the ECU 90 controls the stroke simulator IN valve 27 in the opening direction. At this time, the upstream hydraulic pressure reduces due to the consumption of the upstream hydraulic pressure to increase the pressure of the backpressure chamber 602, but the upstream hydraulic pressure is raised relative to the M/C hydraulic pressure by the maximum upstream hydraulic pressure reduction amount dP_UPPER_ERROR_SSin_MAX when the stroke simulator IN valve is driven, which accompanies the opening of the stroke simulator IN valve 27, and therefore the W/C hydraulic pressure of the maximum hydraulic pressure wheel does not fall below the target W/C hydraulic pressure.

In the third embodiment, the following advantageous effects can be acquired.

(11) The brake apparatus further includes the stroke simulator 6 configured to generate the bake operation reaction force, the third brake circuit (the backpressure chamber pipe 10X, the backpressure oil passage 16, and the first simulator oil passage 17) connecting the backpressure chamber 602 of the stroke simulator 6 and the second brake circuit (the discharge oil passage 13), and the stroke simulator IN valve 27 provided in the third brake circuit. The first target upstream hydraulic pressure calculation portion 90c calculates the third target upstream hydraulic pressure larger than the maximum value of the target wheel cylinder hydraulic pressures of the individual wheels FL to RR (the target W/C hydraulic pressure maximum value) by the amount of the change in the hydraulic pressure in the second brake circuit when the pressure increase valve 22 corresponding to the wheel other than the maximum hydraulic pressure wheel is opened (the maximum upstream hydraulic pressure reduction amount dP_UPPER_ERROR_MAX), and the fourth target upstream hydraulic pressure larger than the hydraulic pressure in the M/C 5 by the amount of the change in the hydraulic pressure in the second brake circuit when the stroke simulator IN valve 27 is opened (the maximum upstream hydraulic pressure reduction amount dP_UPPER_ERROR_SSin_MAX when the stroke simulator IN valve is driven), and sets the larger one of the third target upstream hydraulic pressure and the fourth target upstream hydraulic pressure as the target hydraulic pressure in the second brake circuit (the target upstream hydraulic pressure).

Therefore, the brake apparatus can prevent or cut down the reduction in the W/C hydraulic pressure at the maximum hydraulic pressure wheel when the stroke simulator IN valve 27 is controlled in the opening direction during the ABS control, thereby improving the control accuracy of the control of the W/C hydraulic pressure.

(12) The first target upstream hydraulic pressure calculation step includes calculating the third target upstream hydraulic pressure larger than the maximum value of the target wheel cylinder hydraulic pressures of the individual wheels FL to RR by the amount of the change in the hydraulic pressure in the second brake circuit when the pressure increase valve 22 corresponding to the wheel other than the maximum hydraulic pressure wheel is opened, and the fourth target upstream hydraulic pressure larger than the hydraulic pressure in the M/C 5 by the amount of the change in the hydraulic pressure in the second brake circuit when the stroke simulator IN valve 27 is opened, and setting the larger one of the third target upstream hydraulic pressure and the fourth target upstream hydraulic pressure as the target hydraulic pressure in the second brake circuit.

Therefore, the brake control method can prevent or cut down the reduction in the W/C hydraulic pressure at the maximum hydraulic pressure wheel when the stroke simulator IN valve 27 is controlled in the opening direction during the ABS control, thereby improving the control accuracy of the control of the W/C hydraulic pressure.

### Other Embodiments

Having described the embodiments of the present invention, the specific configuration of the present invention is not limited to the configurations indicated in the embodiments, and the present invention also includes even a design modification thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

For example, when the number of rotations of the motor 20 is controlled in step S4 illustrated in FIG. 3, the number of rotations of the motor may be changed sequentially from moment to moment to reduce the motor noise and the power consumption. In this case, Kp, Ki, Kd, and dP_UPPER_ERROR_MAX can be determined from the number of rotations of the motor changed sequentially from moment to moment, by individually storing into a program Kp, Ki, and Kd adjusted by changing the number of rotations of the motor and dP_UPPER_ERROR_MAX generated at this time.

Regarding the method for controlling the pressure increase valve, the pressure increase valve may be controlled at an intermediate opening degree to reduce a sound generated when the valve is opened/closed. Alternatively, the fully opening/fully closing control and the intermediate opening degree control may be changed sequentially from moment to moment. In this case, the brake apparatus becomes able to determine dP_UPPER_ERROR_MAX from the method for controlling the pressure increase valve that is changed sequentially from moment to moment, by individually storing into the program dP_UPPER_ERROR_MAX when the fully opening/fully closing control and the intermediate opening degree control are performed.

In the following description, other configurations recognizable from the above-described embodiments will be described.

A brake apparatus, according to one configuration thereof, includes a first brake circuit connecting a master cylinder configured to generate a brake hydraulic pressure according to a pedal operation and wheel cylinders configured to generate a braking force on each of wheels of a vehicle by application of the brake hydraulic pressure, a pump configured to increase a pressure of brake fluid in the master cylinder and transmit the brake fluid to the wheel cylinders via a second brake circuit connected to the first brake circuit, pressure increase control valves provided in the first brake circuit on a wheel cylinder side with respect to a portion where the first brake circuit and the second brake circuit are connected to each other, and a first target upstream hydraulic pressure calculation portion configured to calculate a target hydraulic pressure in the second brake circuit in such a manner that the target hydraulic pressure exceeds a maximum value of target wheel cylinder hydraulic pressures of the individual wheels by an amount of a change in the hydraulic pressure in the second brake circuit when the pressure increase control valve corresponding to a wheel other than a maximum hydraulic pressure wheel is opened.

According to further preferable configuration, the above-described configuration further includes a target wheel cylinder hydraulic pressure comparison portion configured to determine whether a difference between the maximum value and a minimum value of the target wheel cylinder hydraulic pressures of the individual wheels exceeds a predetermined value, and a second target upstream hydraulic pressure calculation portion configured to set the target wheel cylinder hydraulic pressure as the target hydraulic pressure in the second brake circuit if the difference is the predetermined value or smaller. The first target upstream hydraulic pressure calculation portion calculates the target hydraulic pressure in the second brake circuit if the difference exceeds the predetermined value.

According to further another preferable configuration, in any of the above-described configurations, the first target upstream hydraulic pressure calculation portion calculates a first target hydraulic pressure acquired by subtracting a predetermined amount from a previous value of the target hydraulic pressure in the second brake circuit, and a second target hydraulic pressure larger than the maximum value of the target wheel cylinder hydraulic pressures of the individual wheels by the amount of the change in the hydraulic pressure in the second brake circuit when the pressure increase control valve corresponding to the wheel other than the maximum hydraulic pressure wheel is opened, and sets a larger one of the first target hydraulic pressure and the second target hydraulic pressure as the target hydraulic pressure in the second brake circuit.

According to further another preferable configuration, any of the above-described configurations further includes a stroke simulator configured to generate a bake operation reaction force, a third brake circuit connecting a backpressure chamber of the stroke simulator and the second brake circuit, and a stroke simulator IN valve provided in the third brake circuit. The first target upstream hydraulic pressure calculation portion calculates a third target hydraulic pressure larger than the maximum value of the target wheel cylinder hydraulic pressures of the individual wheels by the amount of the change in the hydraulic pressure in the second brake circuit when the pressure increase control valve corresponding to the wheel other than the maximum hydraulic pressure wheel is opened, and a fourth target hydraulic pressure larger than a hydraulic pressure in the master cylinder by an amount of a change in the hydraulic pressure in the second brake circuit when the stroke simulator IN valve is opened, and sets a larger one of the third target hydraulic pressure and the fourth target hydraulic pressure as the target hydraulic pressure in the second brake circuit.

According to further another preferable configuration, any of the above-described configurations further includes a hydraulic pressure detection portion configured to detect the hydraulic pressure in the second brake circuit, a fourth brake circuit connecting the second brake circuit and an intake side of the pump, a pressure adjustment valve provided in the fourth brake circuit, and a feedback calculation portion configured to calculate an amount of controlling the pressure adjustment valve by a feedback calculation based on a difference between the hydraulic pressure detected by the hydraulic pressure detection portion and the target hydraulic pressure.

Further, from another aspect, a brake apparatus, according to one configuration thereof, includes a fluid passage of a primary system including a plurality of wheel cylinders in which a pressure can be increased by a master cylinder hydraulic pressure generated in a first chamber of a master cylinder configured to generate a brake hydraulic pressure according to a pedal operation, a fluid passage of a secondary system including a plurality of wheel cylinders in which a pressure can be increased by a master cylinder hydraulic pressure generated in a second chamber of the master cylinder, a communication fluid passage connecting the fluid passage of the primary system and the fluid passage of the secondary system, a pump configured to discharge brake fluid to the communication fluid passage, pressure increase control valves respectively provided in the fluid passages on a wheel cylinder side with respect to a portion where the communication fluid passage and the fluid passages of the primary system and the secondary system are connected to each other, and a target upstream hydraulic pressure calculation portion configured to calculate a target hydraulic pressure in the communication fluid passage in such a manner that the target hydraulic pressure exceeds a maximum value of target wheel cylinder hydraulic pressures of the individual wheels by an amount of a change in a hydraulic pressure in the communication fluid passage when the pressure increase control valve corresponding to a wheel other than a maximum hydraulic pressure wheel is opened.

According to further preferable configuration, the above-described configuration further includes a return flow fluid passage branching from the communication fluid passage between the fluid passage of the primary system and the fluid passage of the secondary system and configured to return the brake fluid discharged into the communication fluid passage to an intake side of the pump, and a pressure adjustment valve provided in the return flow fluid passage.

According to another preferable configuration, any of the above-described configurations further includes a primary cut valve provided in the fluid passage on the master cylinder side with respect to the portion where the communication fluid passage and the primary system are connected to each other, and a secondary cut valve provided in the fluid passage on the master cylinder side with respect to the portion where the communication fluid passage and the secondary system are connected to each other.

Further, from another aspect, a brake control method, according to one configuration thereof, is a brake control method for a brake apparatus including a first brake circuit connecting a master cylinder configured to generate a brake hydraulic pressure according to a pedal operation and wheel cylinders configured to generate a braking force on each of wheels of a vehicle by application of the brake hydraulic pressure, a pump configured to increase a pressure of brake fluid in the master cylinder and transmit the brake fluid to the wheel cylinders via a second brake circuit connected to the first brake circuit, and pressure increase control valves provided in the first brake circuit on one side where the wheel cylinders are located with respect to a portion where the first brake circuit and the second brake circuit are connected to each other. The brake control method includes a target wheel cylinder hydraulic pressure calculation step of calculating a target wheel cylinder hydraulic pressure of each of the wheels based on a state of the vehicle, and a first target upstream hydraulic pressure calculation step of calculating a target hydraulic pressure in the second brake circuit in such a manner that the target hydraulic pressure exceeds a maximum value of the individual target wheel cylinder hydraulic pressures by an amount of a change in the hydraulic pressure in the second brake circuit when the pressure increase control valve corresponding to a wheel other than a maximum hydraulic pressure wheel is opened.

According to another preferable configuration, the above-described configuration further includes a target wheel cylinder hydraulic pressure comparison step of determining whether a difference between the maximum value and a minimum value of the target wheel cylinder hydraulic pressures of the individual wheels exceeds a predetermined value, and a second target upstream hydraulic pressure calculation step of setting the target wheel cylinder hydraulic pressure as the target hydraulic pressure in the second brake circuit if the difference is the predetermined value or smaller. The first target upstream hydraulic pressure calculation step includes calculating the target hydraulic pressure in the second brake circuit if the difference exceeds the predetermined value.

According to further another preferable configuration, in any of the above-described configurations, the first target upstream hydraulic pressure calculation step includes calculating a first target hydraulic pressure acquired by subtracting a predetermined amount from a previous value of the target hydraulic pressure in the second brake circuit, and a second target hydraulic pressure larger than the maximum value of the target wheel cylinder hydraulic pressures of the individual wheels by the amount of the change in the hydraulic pressure in the second brake circuit when the pressure increase control valve corresponding to the wheel other than the maximum hydraulic pressure wheel is opened, and setting a larger one of the first target hydraulic pressure and the second target hydraulic pressure as the target hydraulic pressure in the second brake circuit.

According to further another preferable configuration, in any of the above-described configurations, the first target upstream hydraulic pressure calculation step includes calculating a third target hydraulic pressure larger than the maximum value of the target wheel cylinder hydraulic pressures of the individual wheels by the amount of the change in the hydraulic pressure in the second brake circuit when the pressure increase control valve corresponding to the wheel other than the maximum hydraulic pressure wheel is opened, and a fourth target hydraulic pressure larger than a hydraulic pressure in the master cylinder by an amount of a change in the hydraulic pressure in the second brake circuit when the stroke simulator IN valve is opened, and setting a larger one of the third target hydraulic pressure and the fourth target hydraulic pressure as the target hydraulic pressure in the second brake circuit.

The present application claims priority to Japanese Patent Application No. 2016-40368 filed on Mar. 2, 2016. The entire disclosure of Japanese Patent Application No. 2016-40368 filed on Mar. 2, 2016 including the specification, the claims, the drawings, and the abstract is incorporated herein by reference in its entirety.

### REFERENCE SIGN LIST

FL to RR each wheel
3 pump
5 master cylinder
6 stroke simulator
9 wheel cylinder
10M master cylinder pipe (first brake circuit)
10MP primary pipe (fluid passage of primary system)
10MS secondary pipe (fluid passage of secondary system)
10X backpressure chamber pipe (third brake circuit)
11 supply oil passage (first brake circuit)
11P supply oil passage (fluid passage of primary system)
11S supply oil passage (fluid passage of secondary system)
11a oil passage (fluid passage of primary system)
11b oil passage (fluid passage of secondary system)
11c oil passage (fluid passage of secondary system)
11d oil passage (fluid passage of primary system)
12 intake oil passage (fourth brake circuit, return flow fluid passage)
13 discharge oil passage (second brake circuit)
13P oil passage (communication fluid passage)
13S oil passage (communication fluid passage)
14 pressure adjustment oil passage (fourth brake circuit, return flow fluid passage)
16 backpressure oil passage (third brake circuit)
17 first simulator oil passage (third brake circuit)
21P primary shut-off valve (primary cut valve)
21S secondary shut-off valve (secondary cut valve)
22 pressure increase valve (pressure increase control valve)
24 pressure adjustment valve
27 stroke simulator IN valve
50P primary chamber (first chamber)
50S secondary changer (second chamber)
73 supply oil passage (first brake circuit)
73P supply oil passage (fluid passage of primary system)
73S supply oil passage (fluid passage of secondary system)
90c first target upstream hydraulic pressure calculation portion (target upstream hydraulic pressure calculation portion)
90d second target upstream hydraulic pressure calculation portion
90e target wheel cylinder hydraulic pressure comparison portion
92P primary pressure sensor (hydraulic pressure detection portion)
92S secondary pressure sensor (hydraulic pressure detection portion)
93 discharge pressure sensor (hydraulic pressure detection portion)
95a hydraulic pressure feedback compensator (feedback calculation portion)
120 reservoir (fourth brake circuit)
602 backpressure chamber

1. A brake apparatus comprising:
a first brake circuit connecting a master cylinder configured to generate a brake hydraulic pressure according to a pedal operation and a plurality of wheel cylinders configured to generate a braking force on each of wheels of a vehicle by application of the brake hydraulic pressure to each other;
a pump configured to increase a pressure of brake fluid in the master cylinder, and transmit the brake fluid having the increased pressure to the plurality of wheel cylinders via a second brake circuit connected to the first brake circuit;
a plurality of pressure increase control valves provided in the first brake circuit; and
a first target upstream hydraulic pressure calculation portion configured to calculate a target hydraulic pressure in the second brake circuit in such a manner that the target hydraulic pressure exceeds a maximum value of target wheel cylinder hydraulic pressures of respective wheel cylinders corresponding to the individual wheels by an amount of a change in the hydraulic pressure in the second brake circuit when a pressure increase control valve corresponding to a wheel other than a maximum hydraulic pressure wheel, of the plurality of pressure increase control valves, is opened.

2. The brake apparatus according to claim 1, further comprising:
a target wheel cylinder hydraulic pressure comparison portion configured to determine whether a difference between the maximum value and a minimum value of the target wheel cylinder hydraulic pressures of the individual wheels exceeds a predetermined value; and
a second target upstream hydraulic pressure calculation portion configured to set the target wheel cylinder hydraulic pressure as the target hydraulic pressure in the second brake circuit if the difference is the predetermined value or smaller,
wherein the first target upstream hydraulic pressure calculation portion calculates the target hydraulic pressure in the second brake circuit if the difference exceeds the predetermined value.

3. The brake apparatus according to claim 2, wherein the first target upstream hydraulic pressure calculation portion calculates a first target hydraulic pressure acquired by subtracting a predetermined amount from a previous value of the target hydraulic pressure in the second brake circuit, and a second target hydraulic pressure larger than the maximum value of the target wheel cylinder hydraulic pressures of the respective wheel cylinders corresponding to the individual wheels by the amount of the change in the hydraulic pressure in the second brake circuit when the pressure increase control valve corresponding to the wheel other than the maximum hydraulic pressure wheel is opened, and sets a larger one of the first target hydraulic pressure and the second target hydraulic pressure as the target hydraulic pressure in the second brake circuit.

4. The brake apparatus according to claim 2, further comprising:
a stroke simulator configured to generate a bake operation reaction force;
a third brake circuit connecting a backpressure chamber of the stroke simulator and the second brake circuit; and
a stroke simulator IN valve provided in the third brake circuit,
wherein the first target upstream hydraulic pressure calculation portion calculates a third target hydraulic pressure larger than the maximum value of the target wheel cylinder hydraulic pressures of the respective wheel cylinders corresponding to the individual wheels by the amount of the change in the hydraulic pressure in the second brake circuit when the pressure increase control valve corresponding to the wheel other than the maximum hydraulic pressure wheel is opened, and a fourth target hydraulic pressure larger than a hydraulic pressure in the master cylinder by an amount of a change in the hydraulic pressure in the second brake circuit when the stroke simulator IN valve is opened, and sets a larger one of the third target hydraulic pressure and the fourth target hydraulic pressure as the target hydraulic pressure in the second brake circuit.

5. The brake apparatus according to claim 1, further comprising:
a hydraulic pressure detection portion configured to detect the hydraulic pressure in the second brake circuit;
a fourth brake circuit connecting the second brake circuit and an intake side of the pump;
a pressure adjustment valve provided in the fourth brake circuit; and
a feedback calculation portion configured to calculate an amount of controlling the pressure adjustment valve by a feedback calculation based on a difference between the hydraulic pressure detected by the hydraulic pressure detection portion and the target hydraulic pressure.

6. A brake apparatus comprising:
a fluid passage of a primary system including a plurality of wheel cylinders in which a pressure can be increased by a master cylinder hydraulic pressure generated in a first chamber of a master cylinder configured to generate a brake hydraulic pressure according to a pedal operation;
a fluid passage of a secondary system including a plurality of wheel cylinders in which a pressure can be increased by a master cylinder hydraulic pressure generated in a second chamber of the master cylinder;
a communication fluid passage connecting the fluid passage of the primary system and the fluid passage of the secondary system;
a pump configured to discharge brake fluid to the communication fluid passage;
a plurality of pressure increase control valves respectively provided in the fluid passages of the primary system and the secondary system on a wheel cylinder side with respect to portions where the communication fluid passage and the fluid passages of the primary system and the secondary system are connected to each other; and
a target upstream hydraulic pressure calculation portion configured to calculate a target hydraulic pressure in the communication fluid passage in such a manner that the target hydraulic pressure in the communication fluid passage exceeds a maximum value of target wheel cylinder hydraulic pressures of the respective wheel cylinders corresponding to individual wheels by an amount of a change in a hydraulic pressure in the communication fluid passage when a pressure increase control valve corresponding to a wheel other than a maximum hydraulic pressure wheel, of the plurality of pressure increase control valves, is opened.

7. The brake apparatus according to claim 6, further comprising:
a return flow fluid passage branching from the communication fluid passage between the fluid passage of the primary system and the fluid passage of the secondary system, and configured to return the brake fluid discharged into the communication fluid passage to an intake side of the pump; and
a pressure adjustment valve provided in the return flow fluid passage.

8. The brake apparatus according to claim 7, further comprising:
a primary cut valve provided in the fluid passage of the primary system on the master cylinder side with respect to the portion where the communication fluid passage and the primary system are connected to each other; and
a secondary cut valve provided in the fluid passage of the secondary system on the master cylinder side with respect to the portion where the communication fluid passage and the secondary system are connected to each other.

9. A method for controlling a brake apparatus, the method comprising:
preparing a brake apparatus including
a first brake circuit connecting a master cylinder configured to generate a brake hydraulic pressure according to a pedal operation, and a plurality of wheel cylinders configured to generate a braking force on each of wheels of a vehicle by application of the brake hydraulic pressure,
a pump configured to increase a pressure of brake fluid in the master cylinder, and to transmit the brake fluid having the increased pressure to the wheel cylinders via a second brake circuit connected to the first brake circuit, and
a plurality of pressure increase control valves provided in the first brake circuit;
calculating a target wheel cylinder hydraulic pressure of each of the wheels based on a state of the vehicle; and
calculating, as a first target upstream hydraulic pressure calculation step, a target hydraulic pressure in the second brake circuit in such a manner that the target hydraulic pressure in the second brake circuit exceeds a maximum value of the individual target wheel cylinder hydraulic pressures by an amount of a change in the hydraulic pressure in the second brake circuit when a pressure increase control valve corresponding to a wheel other than a maximum hydraulic pressure wheel, of the plurality of pressure increase control valves, is opened.

10. The method for controlling the brake apparatus according to claim 9, the method further comprising:
determining, as a target wheel cylinder hydraulic pressure comparison step, whether a difference between the maximum value and a minimum value of the target wheel cylinder hydraulic pressures of the respective wheel cylinders corresponding to the individual wheels exceeds a predetermined value; and
setting, as a second target upstream hydraulic pressure calculation step, the target wheel cylinder hydraulic pressure as the target hydraulic pressure in the second brake circuit if the difference is the predetermined value or smaller,
wherein the first target upstream hydraulic pressure calculation step includes calculating the target hydraulic pressure in the second brake circuit if the difference exceeds the predetermined value.

11. The method for controlling the brake apparatus according to claim 10, wherein the first target upstream hydraulic pressure calculation step includes calculating a first target hydraulic pressure acquired by subtracting a predetermined amount from a previous value of the target hydraulic pressure in the second brake circuit, and a second target hydraulic pressure larger than the maximum value of the target wheel cylinder hydraulic pressures of the respective wheel cylinders corresponding to the individual wheels by the amount of the change in the hydraulic pressure in the second brake circuit when the pressure increase control valve corresponding to the wheel other than the maximum hydraulic pressure wheel is opened, and setting a larger one of the first target hydraulic pressure and the second target hydraulic pressure as the target hydraulic pressure in the second brake circuit.

12. The method for controlling the brake apparatus according to claim 10, wherein the first target upstream hydraulic pressure calculation step includes:
calculating a third target hydraulic pressure larger than the maximum value of the target wheel cylinder hydraulic pressures of the respective wheel cylinders corresponding to the individual wheels by the amount of the change in the hydraulic pressure in the second brake circuit when the pressure increase control valve corresponding to the wheel other than the maximum hydraulic pressure wheel is opened, and a fourth target hydraulic pressure larger than a hydraulic pressure in the master cylinder by an amount of a change in the hydraulic pressure in the second brake circuit when the stroke simulator IN valve is opened; and
setting a larger one of the third target hydraulic pressure and the fourth target hydraulic pressure as the target hydraulic pressure in the second brake circuit.

13. The brake apparatus according to claim 1, wherein, at the time of a pressure increase in a case where the respective wheel cylinders corresponding to the individual wheels are separately controlled during ABS control, the brake apparatus preferentially open a pressure increase control valve corresponding to a wheel cylinder having a relatively large difference between the target wheel cylinder hydraulic pressure and an estimated wheel cylinder hydraulic pressure, of the individual wheel cylinders.

14. The brake apparatus according to claim 1, wherein, at the time of a pressure increase in a case where the respective wheel cylinders corresponding to the individual wheels are separately controlled during ABS control, the brake apparatus preferentially open a pressure increase control valve corresponding to a wheel cylinder corresponding to a wheel on which a deceleration relatively easily occurs, of the individual wheel cylinders.

15. A brake apparatus comprising:
a fluid passage of a primary system including a plurality of wheel cylinders in which a pressure can be increased by a master cylinder hydraulic pressure generated in a first chamber of a master cylinder configured to generate a brake hydraulic pressure according to a pedal operation;
a fluid passage of a secondary system including a plurality of wheel cylinders in which a pressure can be increased by a master cylinder hydraulic pressure generated in a second chamber of the master cylinder;
a communication fluid passage connecting the fluid passage of the primary system and the fluid passage of the secondary system;
a pump configured to discharge brake fluid to the communication fluid passage;
a plurality of pressure increase control valves respectively provided in the fluid passages of the primary system and the secondary system on a wheel cylinder side with respect to portions where the communication fluid passage and the fluid passages of the primary system and the secondary system are connected to each other;
a stroke simulator configured to generate a reaction force of the pedal operation;
a backpressure fluid passage connecting a backpressure chamber of the stroke simulator and the communication fluid passage; and
a stroke simulator IN valve provided in the backpressure fluid passage,
wherein a hydraulic pressure in the communication fluid passage during ABS control is higher than the master cylinder hydraulic pressure.
